(19) United States
(12) Patent Application Publication
(10) Pub. No.: US 2025/0117251 A1
(43) Pub. Date: Apr. 10, 2025

(54) SCHEDULING AND INITIALIZING SOFTWARE EXECUTION SCHEDULES

(71) Applicant: NVIDIA Corporation, Santa Clara, CA (US)

(72) Inventors: Eric COLTER, Rockford, MI (US); Arun SHAMANNA LAKSHMI, San Jose, CA (US); Gordon Grigor, San Francsico, CA (US)

(21) Appl. No.: 18/483,404

(22) Filed: Oct. 9, 2023

(51) Int. Cl. G06F 9/48

(52) U.S. Cl. CPC G06F 9/4881; G06F 9/485; G06F 2209/485

(57) ABSTRACT

Embodiments of the present disclosure relate to a system and method used to schedule and initiate execution of one or more tasks. The system may include processing units that may perform operations that may include obtaining execution information that may correspond to a first task and a second task. In some embodiments, the first task may include first operations and where the second task may include second operations. In some embodiments, the operations may further include determining a time to initialize execution of the first task and the second task based at least on the execution information. In some embodiments, execution of the first task may be executed on a first computing system and the second task may be executed on a second computing system where the execution of the first operations and the second operations is interdependent.

### BACKGROUND

Software development corresponding to some systems-particularly complex systems, such as, for example, robotic systems, autonomous or semi-autonomous vehicles, drones, and other systems-use a complex interplay of software and hardware to achieve various outcomes. As software becomes more advanced, the need to test various portions of software becomes more urgent. Furthermore, as operations performed using software become more specialized, the variability in computing resources to perform specialized operations also increases.

An example challenge facing software developers is a finite number of computing resources and/or processing resources that may be configured to perform and/or execute one or more tasks and/or processes associated with the software and/or associated hardware. In some instances, software testing may be an important part of the developing and debugging process for many complex systems. In many instances, software corresponding to multiple processes, projects, portions of code, tasks, etc. may need to be tested on a finite number of computing resources, computing platforms, processors, etc.

Some traditional approaches to software testing may rely solely on manual execution of the one or more tasks or executing interdependent tasks on the same computing system. However, an example limitation of the traditional approaches may be the expense and expertise required for manual execution of various tasks—e.g., using time and expertise of software developers. Furthermore, executing tasks manually or on the same type of computing system may decrease efficient use of computing resources that, used differently, may be configured to perform more testing operations in a shorter amount of time.

### SUMMARY

According to one or more embodiments of the present disclosure, a system may be configured to perform one or more operations associated with testing and/or executing one or more software workflows. For example, a language may be used to specify workflows as, without limitation, a directed acyclic graph of groups, where a group may include a collection of one or more tasks with parallel dependencies that must be schedule simultaneously. The workflow specification may allow users to build a DAG where the nodes are groups and edges represent serial dependencies between the groups. In some embodiments, each task may declare specific resource requirements so that the task can be schedule onto a node with the appropriate resources. By using such a workflow specification, a developer (e.g., a robotics developer) may describe complex workflows in a way that is reproducible and able to be consumed and executed automatically by a workflow execution system.

The system, in embodiments, may include a workflow engine for executing workflows submitted by users using the workflow specification. Groups may be executed on an execution backend-such as using a cluster in a container orchestration system-which supports running tasks in parallel simultaneously. In some embodiments, when a user submits a workflow, groups in the workflow are added to a database with a counter for each group to keep track of how many uncompleted upstream groups it has. The groups in the workflow with no upstream dependencies are submitted to, for example, the cluster. The system may then monitor the cluster for completed groups. When a group completes execution, the system may decrement the counter for all of the completed group's downstream groups in the database. If a group's counter is decremented to zero, then that means that all of its upstream groups have completed, its serial dependencies have been satisfied, and hence it is ready for execution. At this time, the system may submit that group to the cluster for execution. This may continue until all groups in the workflow have completed.

In some embodiments, the system may include one or more processors that may be configured to perform one or more operations. In some embodiments, the operations may include obtaining execution information corresponding to a first task and a second task. In some embodiments, the first task may include one or more first containers that may include one or more first operations and the second task may include one or more second containers that may include second operations.

In some embodiments, the obtained execution information may identify one or more first dependencies that may correspond to the first task and one or more second dependencies corresponding to the second task. Further the obtained execution information may include a first computing system on which the first task may be executed and a second computing system on which the second task may be executed. In some embodiments, the first computing system and the second computing system that may be identified using the obtained execution information may be different computing systems.

In some embodiments, the operations may include determining a time to initialize execution of the first task and the second task. In some embodiments, the determined time may be based on the obtained execution information. In some embodiments, the execution of the first task on the first computing system may be initialized. Additionally or alternatively, the execution of the second task corresponding to the second computing system may be initialized. In some embodiments, the execution of the first task and the second task may be executed at the determined time. In some embodiments, the execution of the one or more first containers associated with the first task and the one or more second containers associated with the second task may be interdependent.

The embodiments of the present disclosure may allow for automatic execution of one or more interdependent tasks on multiple, respective types of computing resources. Additionally, embodiments of the present disclosure may increase efficiency in using processing resources by automatically initiating execution of interdependent tasks, the interdependent tasks executed on different types of computing resources and at the same time or substantially the same time.

### BRIEF DESCRIPTION OF THE DRAWINGS

The present systems and methods for scheduling and initializing software execution schedules are described in detail in the present disclosure with reference to the attached drawing figures, wherein:

FIG. 1 illustrates an example environment for scheduling and executing tasks corresponding to a workflow, in accordance with one or more embodiments of the present disclosure;

FIG. 2 is an example implementation of an execution schedule, in accordance with one or more embodiments of the present disclosure;

FIG. 3A illustrates an example environment for generating one or more execution schedules using one or more workflows, in accordance with one or more embodiments of the present disclosure;

FIG. 3B is an example implementation of a scheduler designating one or more containers to be executed, in accordance with one or more embodiments of the present disclosure;

FIG. 4 illustrates an example environment for generating one or more outputs based on executing one or more workflows corresponding to one or more execution schedules, in accordance with one or more embodiments of the present disclosure;

FIG. 5 is a flow diagram showing a method for initializing execution of one or more tasks corresponding to respective workflows, in accordance with one or more embodiments of the present disclosure;

FIG. 6A is an illustration of an example autonomous vehicle, in accordance with some embodiments of the present disclosure;

FIG. 6B is an example of camera locations and fields of view for the example autonomous vehicle of FIG. 6A, in accordance with some embodiments of the present disclosure;

FIG. 6C is a block diagram of an example system architecture for the example autonomous vehicle of FIG. 6A, in accordance with some embodiments of the present disclosure;

FIG. 6D is a system diagram for communication between cloud-based server(s) and the example autonomous vehicle of FIG. 6A, in accordance with some embodiments of the present disclosure;

FIG. 7 is a block diagram of an example computing device suitable for use in implementing some embodiments of the present disclosure; and

FIG. 8 is a block diagram of an example data center suitable for use in implementing some embodiments of the present disclosure.

### DETAILED DESCRIPTION

One or more embodiments of the present disclosure may relate to software testing corresponding to one or more tasks associated with one or more workflows. A “task” may include an invocation of one or more software tools. In some instances, for example, individual tasks may respectively include several different operations that may be performed and/or executed using one or more computing resources—e.g., by invoking or calling one or more functions. Executing a task may include executing one or more operations that may correspond to the task. In some instances, executing a task may include executing each of the operations that may be associated with the task. In some embodiments, the one or more operations corresponding to a task may include a discrete executable that may include one or more lines of code, one or more.exe files, and/or any other discrete operation that may be executed using one or more computing systems.

For example, a task may include “data processing” corresponding to a particular dataset. In some instances, the task may include all operations corresponding to data processing of the particular dataset. By contrast, in other instances, the task may include a subset of the operations corresponding to data processing of the particular dataset. Continuing the example, the one or more operations that may be included in the task may include one or more sub-processes performed and/or executed in performing the data processing task. Additionally or alternatively, the operations may include one or more other discrete operations that may be executed using one or more computing systems—e.g., extracting one or more portions of the dataset, parsing the dataset, etc.

In some instances, one or more tasks may be scheduled to run based on dependencies, available computing resources, and one or more types of computing resources that may be indicated based on the one or more tasks (e.g., a CPU, GPU, DPU, etc.). A collection of one or more tasks may be referred to herein as a “workflow.” The workflow may include one or more tasks that may be interdependent. For example, a first task may include generating a test scene used to run one or more simulations corresponding to particular data. Continuing the example, a second task may include the one or more simulations that may be run using one or more generated test scenes. Because the second task may only be executed after the first task is executed, the second task may depend from the first task. Further continuing the example, in the workflow, the second task may be scheduled to be executed only after the first task may be executed.

In some embodiments, different tasks may be executed by different types of computing systems based on the indicated types of computing platforms that may be used to execute particular tasks. Different types of computing systems may include systems that may be used for differing purposes. For example, different types of computing systems may include different types of central processing units (CPUs), graphics processing units (GPUs), tensor processing units (TPUs), field programmable gate arrays (FPGAs), etc.

According to one or more embodiments of the present disclosure, multiple tasks may be designated for execution or otherwise scheduled to be executed as a part of a workflow. In particular, the workflow may include one or more instances where a first task may be designated for execution using a first type of computing system and a second task may be designated for execution on a second type of computing system at the same time, or substantially the same time. Further, one or more containers corresponding to the first task and one or more containers corresponding to the second task may be interdependent. In particular, one or more operations corresponding to a particular container of the first task may be dependent from one or more operations corresponding to a particular container in the second task.

One or more embodiments of the present disclosure may enable automatic executing one or more interdependent tasks on multiple, respective types of computing platforms. One or more embodiments described herein may increase efficiency in using computing resources by automatically initiating execution of interdependent tasks, the interdependent tasks executed on different types of computing platforms and at the same time or substantially the same time.

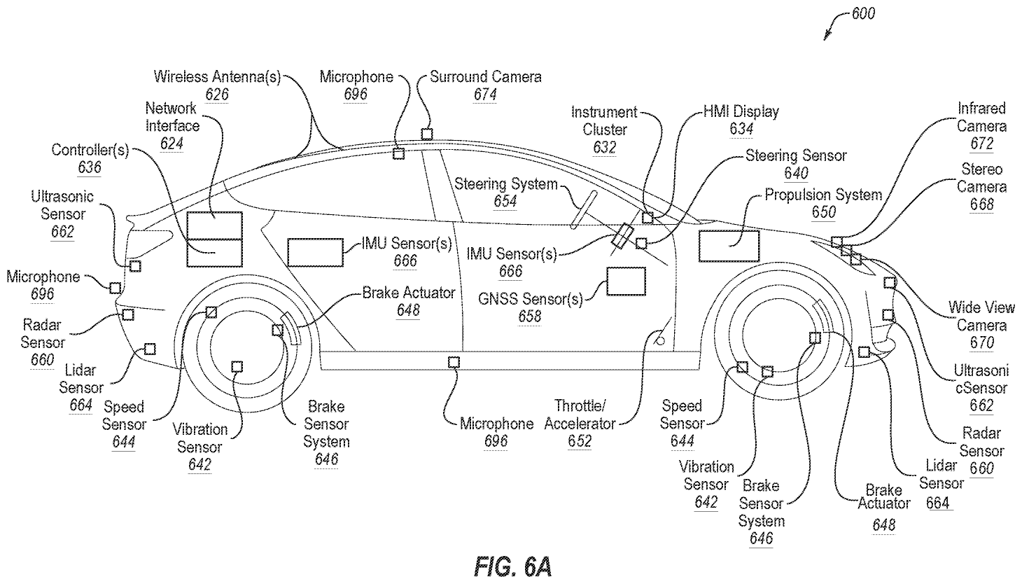

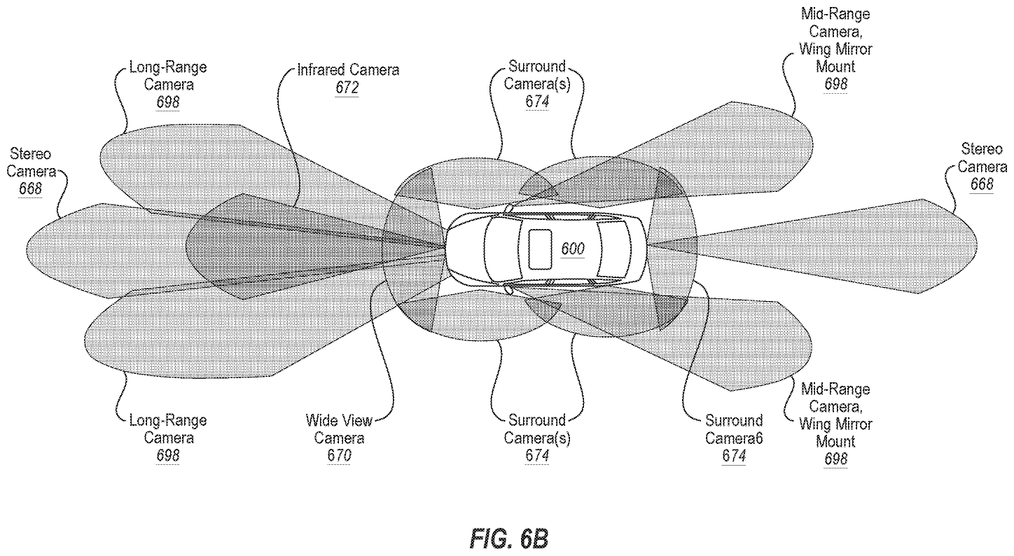

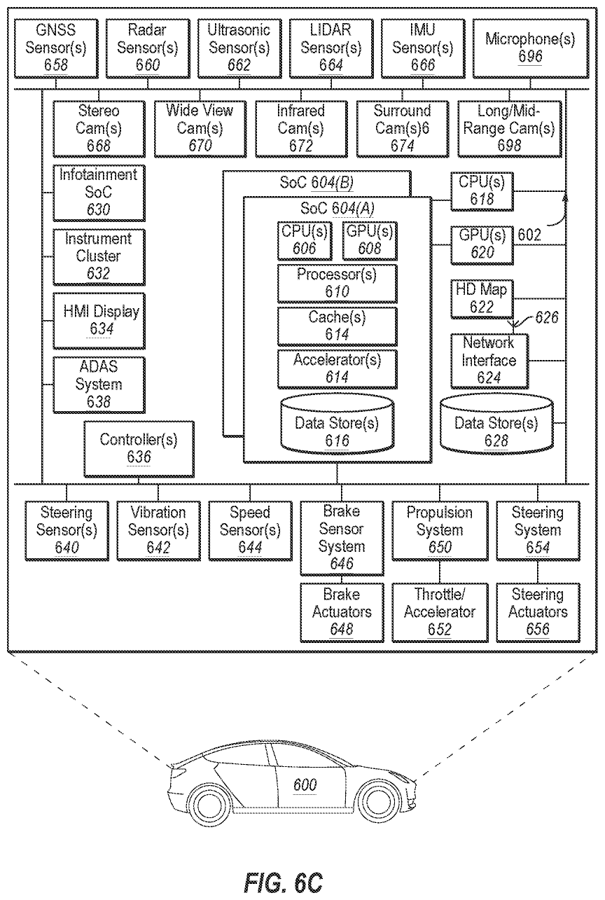

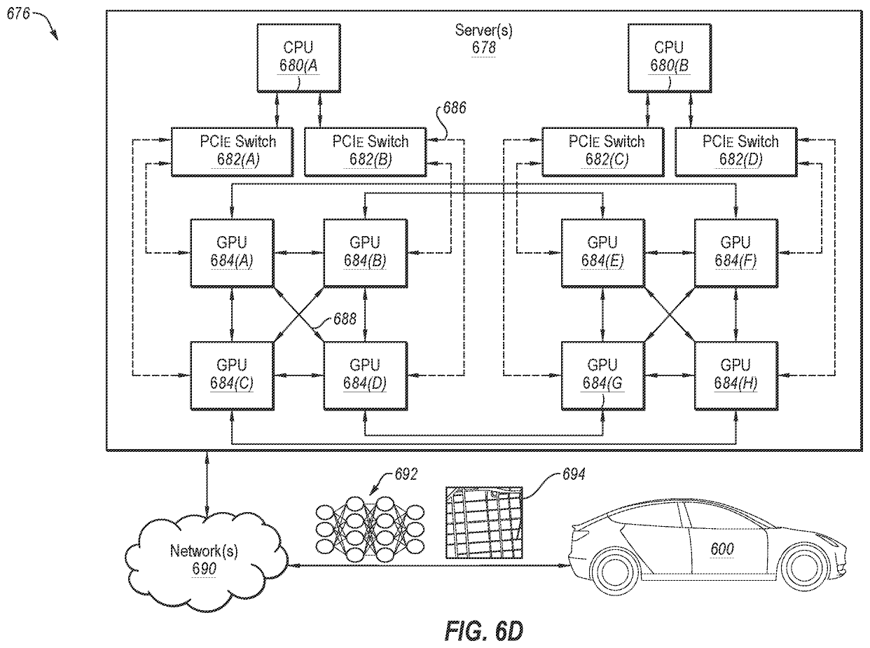

One or more of the embodiments disclosed herein may relate to workflow testing and/or execution that may be performed using one or more ego-machines, which may include any applicable machine or system that is capable of performing one or more autonomous and/or semi-autonomous operations. Example ego-machines may include, but are not limited to, vehicles (land, sea, space, and/or air), robots, robotic platforms, warehouse/factory vehicles or machines, etc. By way of example, the ego-machine computing applications may include one or more applications that may be executed by an autonomous vehicle or semi-autonomous vehicle, such as an example autonomous or semi-autonomous vehicle or machine 600 (alternatively referred to herein as “vehicle 600” or “ego-machine 600”) described with respect to FIGS. 6A-6D. In the present disclosure, reference to an “autonomous vehicle” or “semi-autonomous vehicle” may include any vehicle that may be configured to perform one or more autonomous or semi-autonomous navigation or driving operations. As such, such vehicles may also include vehicles in which an operator is required or in which an operator may perform such operations as well.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems that implement one or more language models, such as one or more large language models (LLMs) that process textual, audio, image, sensor, and/or other data types to generate one or more outputs, systems for hosting real-time streaming applications, systems for presenting one or more of virtual reality content, augmented reality content, or mixed reality content, systems for performing light transport simulation, systems for performing collaborative content creation for 3D assets, systems for performing one or more generative AI operations, systems implemented at least partially using cloud computing resources, and/or other types of systems.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

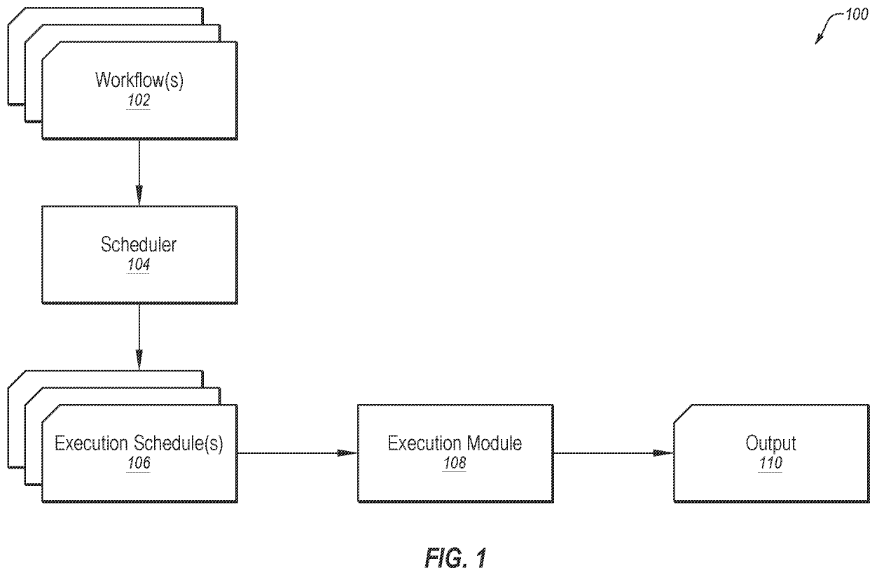

Now referring to FIG. 1, FIG. 1 illustrates an example environment 100 for scheduling and/or executing tasks corresponding to a workflow 102, in accordance with one or more embodiments of the present disclosure. In some embodiments, the environment 100 may correspond to one or more machines, systems, subsystems, and/or collection of processes that may include software that may be tested and/or executed. For example, the workflow 102 may correspond to one or more autonomous or semi-autonomous systems, ego-machines, robots, drones, subsystems of the foregoing, etc.

In some embodiments, the environment 100 may include a scheduler 104 that may be configured to generate one or more workflow execution schedules 106 based on the workflow(s) 102. Additionally or alternatively, the environment 100 may include an execution module 108 that may be configured to execute the workflow(s) 102 and/or initiate execution of the workflow(s) 102 based on the one or more execution schedules 106.

In some embodiments, the workflow 102 may include one or more tasks. In some embodiments, individual tasks may respectively include an invocation of one or more software tools. In some instances, for example, individual tasks may respectively include several different operations that may be performed and/or executed using one or more computing resources—e.g., by invoking or calling one or more functions.

In some embodiments, operations corresponding to a particular task may be organized in one or more containers. The one or more containers may include a standalone software package whereby operations organized in the container may be executed. In some instances a container may include, for example, runtime, system tools, system settings, information on how to execute the operations corresponding to the container, etc. In some embodiments, reference to executing a container may include executing one or more operations that may be organized in a particular container. In some embodiments, reference to executing a task may include executing one or more containers corresponding to the task. Additionally or alternatively, in some embodiments, reference to executing a task may include executing each of the containers corresponding to the task.

In some embodiments, the workflow 102 may include a collection of tasks that may be used to accomplish a particular goal. For example, the workflow 102 may include generating and/or training a particular machine learning algorithm, module, and/or system to generate a particular output. In some embodiments, training a machine learning algorithm may be performed by one or more individual tasks, such as, for example, processing input data as a first task, training one or more artificial intelligence (“AI”) models using the input data as a second task, evaluating the trained AI models as a third task, generating a testing scenario as a fourth task, etc. In some embodiments, the collection of tasks included in training a particular AI model may be included in the workflow 102.

In some embodiments, the workflow 102 may include tasks associated with the same system, subsystem, processes, etc. For example, the workflow 102 may correspond to operations performed using a perception system or subsystem corresponding to an ego-machine. Continuing the example, the workflow 102 may include a first task that may be configured to train a machine learning model to identify objects based on input data (e.g., image data, Radio Detection and Ranging (“RADAR”) data, Light Detection and Ranging (“LiDAR”) data, etc.). Further continuing the example, the workflow 102 may additionally include a second task that may correspond to generating one or more control commands based on the data that may be generated using the machine learning models that may have been trained using the first task.

In some embodiments, by contrast, the workflow 102 may include tasks that may not be associated with the same system, subsystems, processes, etc. Rather, the tasks included in respective workflows 102 may include tasks corresponding to separate systems, subsystems, processes, etc. For example, the workflow 102 may include a first task that may correspond to a perception system or subsystem that may be associated with an ego-machine. Continuing the example, the workflow 102 may include a first task that may be configured to train one or more machine learning models to identify objects based on input data (e.g., image data, RADAR data, LiDAR data, etc.). Further continuing the example, the workflow 102 may include a second task that may correspond to a communication subsystem associated with the ego-machine. The second task may be configured to detect one or more errors corresponding to one or more communication systems that may be configured to transmit and/or receive data.

In some embodiments, an individual workflow 102 may include one or more tasks that may depend from one or more other tasks within the individual workflow 102. For example, the workflow 102 may include a first task and a second task. The first task may include generating a test scene used to run one or more simulations corresponding to particular data. Continuing the example, the second task may include the one or more simulations that may be run using one or more generated test scenes. Because the second task may only be executed after the first task is executed, the second task may depend from the first task. Further continuing the example, in the workflow 102, the second task may be scheduled to be executed only after the first task may be executed.

In some embodiments, two or more tasks corresponding to the workflow 102 may be interdependent. Two or more interdependent tasks included in the workflow 102 may be referred to herein as a “group.” For example, the workflow 102 may include a group including a first task and a second task. The first task may include one or more operations that may be dependent on executing the second task and, correspondingly, the second task may include one or more operations that may be dependent on executing the first task. Further continuing the example, because the first task and the second task may include operations that may be interdependent, the first task and the second task may be executed at the same time or substantially the same time.

In some embodiments, individual tasks may be designated for execution by different computing platforms. In some embodiments, computing platforms may include one or more environments including hardware and software on which applications and software systems run and/or operate. Different types of computing platforms may include central processing units (CPUs), graphics processing units (GPUs), tensor processing units (TPUs), field programmable gate arrays (FPGAs), application-specific integrated circuits (ASICs), accelerators (e.g., deep learning accelerators (DLAs)), and/or other computing platforms. Additionally or alternatively, different types of computing platforms may include different types of CPUs, GPUs, TPUs, FPGAS, ASICS, DLAs, accelerators, etc. For example, a first type of GPU may be better suited for image and/or video processing while a second type of GPU may be better suited for training machine learning models. Continuing the example, the first type of GPU may be a first type of computing platform and the second type of GPU may be a second type of computing platform.

In some embodiments, a particular task may be designated for execution only by a particular computing platform. For example, a first task may be designated for execution only using a particular GPU. Additionally or alternatively, a particular task may be designated for execution by a number of different computing platforms. For example, a first task may be designated for execution using multiple different types of CPUs and multiple different types of GPUs.

In some embodiments, the workflow 102 may designate that one or more tasks may be executed using different computing platforms. In some embodiments, a first task may be designated for execution using a first type of computing platform and a second task may be designated for execution using a second type of computing platform. For example, the workflow 102 may designate a first task and a second task for execution, where the first task and the second task may be associated with a same system or machine (e.g., an ego-machine). Continuing the example, the first task may include one or more operations related to signal processing that may be executed using one or more FPGAs. Further continuing the example, the second task may include one or more image processing operations that may be executed using one or more GPUs.

In some embodiments, the workflow 102 may be generated using details provided by one or more systems, entities, users, etc. For example, a system may generate a workflow—e.g., a spec or a directed acyclic graph (“DAG”)-associated with executing a collection of tasks that may be associated with the workflow 102. In some embodiments, the workflow 102 may include one or more interdependencies between the one or more tasks and/or containers included in the one or more tasks. Additionally or alternatively, the one or more users, entities, systems, etc. may specify types of computing platforms on which the one or more tasks and/or containers corresponding to the one or more tasks associated with the workflow 102 may be executed.

In some embodiments, the workflow 102 may include execution information corresponding to the tasks and/or containers corresponding to the workflow 102. In some embodiments, the execution information corresponding to the workflow 102 may specify the tasks and/or containers corresponding to the specified tasks to be executed. In some embodiments, the execution information may include information regarding computing platforms with which to execute the one or more tasks and/or containers associated with the workflow 102. In some embodiments, the workflow 102 may include information regarding dependencies between tasks, containers, and/or operations associated with the workflow 102.

Additionally or alternatively, the execution information corresponding to the workflow 102 may include timeout information indicating a threshold of time that may indicate when the task may be automatically ended in response to the task not being complete. Additionally or alternatively, execution information may indicate the system, user, entity, etc. that may be requesting execution of tasks corresponding to the workflow 102. In some embodiments, the execution information corresponding to the workflow may indicate an amount of computing resources required to execute tasks corresponding to the workflow 102.

In some embodiments, the workflow 102 may be sent, transmitted, or otherwise communicated to the scheduler 104. In some embodiments, the workflow 102 may be received and/or otherwise obtained by the scheduler 104. In some embodiments, the scheduler 104 may be configured to schedule, based on the workflow 102 and the information included therein, one or more tasks corresponding to the workflow 102 for execution.

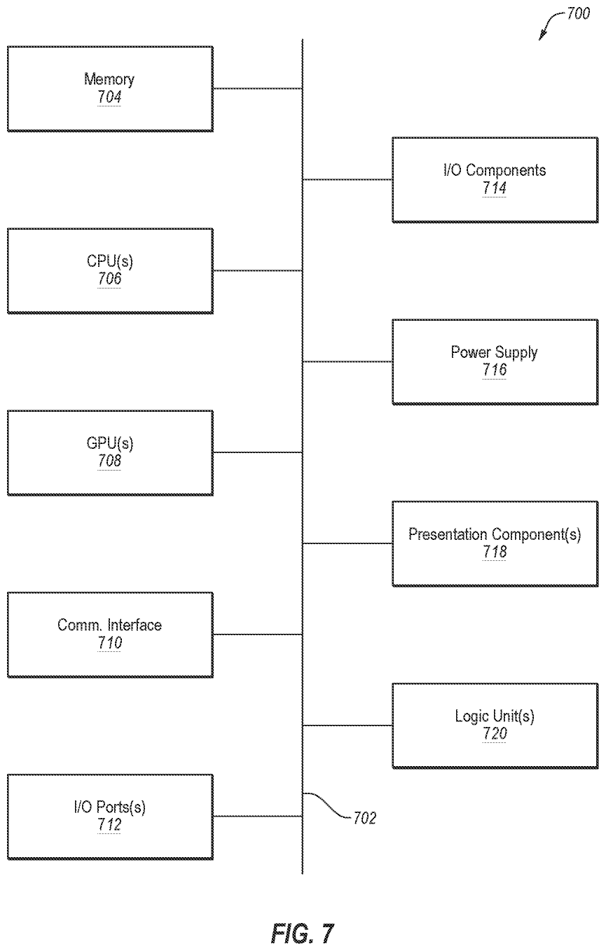

In some embodiments, the scheduler 104 may include code and routines configured to allow a computing system to perform one or more operations. Additionally or alternatively, the scheduler 104 may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In these and other embodiments, the scheduler 104 may be implemented using a combination of hardware and software. In the present disclosure, operations described as being performed by the scheduler 104 may include operations that the scheduler 104 may direct a corresponding computing system to perform. In these or other embodiments, the scheduler 104 may be implemented by one or more computing devices, such as that described in further detail with respect to FIGS. 6A-6D, 7, and/or 8.

In some embodiments, the scheduler 104 may be configured to generate one or more workflow execution schedules 106 based on the execution information provided in the workflow(s) 102. For example, the scheduler 104 may be configured to schedule tasks corresponding to a workflow 102 based on the dependencies corresponding to the tasks. For example, scheduling a second task to be executed after a first task in the instance where the second task depends from the first task. In some embodiments, the scheduler 104 may indicate execution sequencing and/or timing of the tasks. In these or other embodiments, the scheduler 104 may be indicate different computing platforms (e.g., GPUs, CPUs, accelerators, VPUs, DPUs, PPUs, etc.) to manage the execution of corresponding tasks.

In some embodiments, the scheduler 104 may be configured to schedule one or more tasks for execution based on the amount of computing resources that may be used to execute the one or more tasks. For example, individual tasks that may be executed on the same computing platform may be scheduled to be executed sequentially or concurrently based on the computing resources that may be used to execute the individual tasks. In some embodiments, the scheduler 104 may be configured to schedule one or more tasks corresponding to a workflow 102 to be executed based on the system, user, entity, etc. that may be requesting execution of tasks. For example, certain systems, entities, users, etc. may be given a priority status over one or more other tasks and/or workflows 102.

In some embodiments, the scheduler 104 may be configured to schedule one or more tasks for execution based on computing platform designations. For example, the workflow(s) 102 may designate one or more computing platforms on which one or more tasks may be executed. In some embodiments, the scheduler 104 may be configured to schedule one or more tasks for execution based on respective designations corresponding to the one or more tasks included in the workflow 102.

In some embodiments, the scheduler 104 may be configured to schedule one or more tasks to be executed based on one or more groups that may be identified corresponding to the workflow 102. For example, a first group may include a first task and a second task that may be interdependent and therefore the first task and the second task may be executed at the same time or substantially the same time. In some embodiments, the scheduler 104 may only schedule the first task and the second task to be executed when the computing resources may be available to handle both the first task and the second task at the same time or substantially the same time.

In some embodiments, the scheduler 104 may be configured to schedule one or more tasks dynamically. In some embodiments, the scheduler 104 may be configured to generate a queue of tasks to execute based on the one or more workflows 102. In some embodiments, the scheduler 104 may be configured to designate one or more tasks in the generated queue for execution during runtime. In some embodiments, the designation of one or more tasks may be determined based on the execution information corresponding to the workflow(s) 102 as well as availability of computing resources during runtime. In some embodiments, dynamically scheduling one or more tasks in real time or substantially real time may increase an efficient use of computing resources and/or decrease the amount of time that it may take to execute tasks corresponding to one or more workflows 102.

In some embodiments, the availability of computing resources may be determined and/or assessed at runtime. In some embodiments, the current availability of computing resources corresponding to one or more computing platforms may be assessed to dynamically schedule the tasks to execute.

For example, a first workflow 102 may include a first task and a second workflow 102 may include a second task, where the first task and the second task may both be queued up to be scheduled for execution. Continuing the example, the first task may require a first amount of computing resources to execute and the second task may require a second amount of computing resources to execute, where the first amount of computing resources is larger than the second amount of computing resources. Further continuing the example, the first task and the second task may both be designated to be executed on a same computing platform. The current availability of computing resources corresponding to the computing platform may be assessed prior to determining whether to schedule one or more of the first task and the second task. In some instances, the scheduler 104 may determine that only enough computing resources are available to schedule the second task for execution. Additionally or alternatively, in some instances, the current availability of computing resources may be enough to schedule both the first task and the second task together. Additionally or alternatively, in some instances, the current availability of computing resources may not be enough to schedule either the first task or the second task and the scheduler 104 may be configured to wait until computing resources become available to schedule the first task and/or the second task for execution.

In some embodiments, the scheduler 104 may generate one or more execution schedules 106 that may indicate execution sequencing and/or timing of the tasks. For example, the one or more execution schedules 106 may indicate an execution order of the tasks, which computing platform may execute a respective task, and/or timing constraints with respect to the tasks (e.g., how much time is allotted for each respective task and/or timing regarding when the respective tasks should begin and/or end).

In some embodiments, the one or more execution schedules 106 may include one or more stages at which one or more tasks may be scheduled to be executed. In some embodiments, a stage may refer to a discrete period in which one or more tasks may be executed. In some embodiments, one or more tasks corresponding to the workflow 102 may be executed in different stages based on the dependencies between tasks, the amount of computing resources available, the amount of time to execute the tasks, and/or other factors that may indicate that one task may be executed in a particular stage that may be different from or the same as a stage at which one or more other tasks may be executed. In some embodiments, a group may be scheduled in a single stage such that the two or more tasks included in the group may be executed at the same time or substantially the same time.

In some embodiments, different stages may include tasks that may be executed at discrete times one after another. For example, in a workflow including two stages, the first stage may be executed and, after the first stage is complete, the second stage may begin. Additionally or alternatively, stages may be executed concurrently. For example, in a workflow including two stages, one or more tasks corresponding to the first stage may begin to be executed and, before the one or more tasks have completed execution, one or more tasks corresponding to the second stage may begin to be executed.

In some embodiments, an execution schedule 106 indicating that one or more tasks may be executed at a particular stage may indicate that execution of the stage may be initiated and then execution of a subsequent stage may then be initiated. For example, the workflow 102 may include a first stage and a second stage where the first stage may include a first task to be executed and the second stage may include a second task to be executed. Continuing the example, the execution schedule 106 may indicate that the first task corresponding to the first stage may be executed first and the second task corresponding to the second stage may be executed at some period after beginning the execution of the first task corresponding to the first stage.

In some embodiments, the one or more execution schedules 106 may be transmitted, sent, or otherwise communicated to the execution module 108. In some embodiments, the execution module 108 may be configured to receive and/or otherwise obtain the one or more execution schedules 106.

In some embodiments, the execution module 108 may include code and routines configured to allow a computing system to perform one or more operations. Additionally or alternatively, the execution module 108 may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In these and other embodiments, the execution module 108 may be implemented using a combination of hardware and software. In the present disclosure, operations described as being performed by the execution module 108 may include operations that the execution module 108 may direct a corresponding computing system to perform. In these or other embodiments, the execution module 108 may be implemented by one or more computing devices, such as that described in further detail with respect to FIGS. 6A-6D, 7, and/or 8.

The execution module 108 may be configured to execute the tasks corresponding to the workflows 102 as scheduled for execution in the execution schedule(s) 106. In some embodiments, the execution module 108, rather than executing the tasks corresponding to respective workflows 102, the execution module 108 may be configured to initiate execution of the one or more tasks corresponding to respective workflows 102 based on the execution schedule(s) 106, where the execution is performed using one or more other computing resources—e.g., one or more CPUs, GPUs, DPUs, FPGAs, etc.

In some embodiments, the execution module 108 may be configured to monitor the one or more tasks being executed. In some embodiments, the execution module 108 may be configured to receive and/or extract one or more errors that may have been generated during execution of the tasks. For example, the errors may include any number of errors, such as, for example, syntax errors corresponding to the code, type errors, resource errors, networking errors, errors corresponding to hardware limitations, memory errors, and any other error that may be encountered during the execution of the tasks corresponding to respective workflows 102.

In some embodiments, the execution module 108 may be configured to pause and/or stop the execution of one or more tasks by the one or more computing platforms. In some embodiments, the execution module 108 may stop and/or pause the execution of one or more tasks based on the one or more detected errors. Additionally or alternatively, the execution module 108 may be configured to stop and/or pause the execution of one or more tasks based on individual tasks being executed past a predetermined amount of time. In some embodiments, the predetermined amount of time may be a multiple of an expected amount of time to execute the task. In some embodiments, the expected amount of time may be included in the workflow 102 and may be included to efficiently use computing resources in instances where the task may be caught in a loop and may run perpetually, for example.

In some embodiments, the execution module 108 may be configured to generate a queue of tasks that may be run based on an amount of computing resources currently available. For example, the workflow execution schedule 106 may indicate that multiple different tasks may be executed using a first computing platform. Continuing the example, in instances where the CPU may not be able to handle execution of the multiple tasks at one time, the execution module 108 may manage a queue based on the workflow execution schedule(s) 106 associated with the tasks.

In some embodiments, the execution module 108 may additionally be configured to extract execution information generated based on executing one or more tasks. In some embodiments, for example, logs may be generated based on executing the one or more tasks and the execution module 108 may be configured to send and/or communicate the logs to one or more other systems, machines, users, entities, etc.

In some embodiments, the execution module 108 may be configured to generate the output 110. In some embodiments, the output 110 may include information corresponding to the execution of the one or more tasks,

In some embodiments, the output 110 may include information corresponding to detected errors associated with the execution of one or more tasks. Additionally or alternatively, the output 110 may include notifications including, for example, the execution module 108 stopping and/or pausing execution of one or more tasks.

In some embodiments, the output 110 may be sent or otherwise communicated to one or more other systems, entities, users, etc. For example, the output 110 may be communicated to the entity or system that may have generated the workflow(s) 102.

Modifications, additions, or omissions may be made to FIG. 1 without departing from the scope of the present disclosure. For example, the number of tasks included in individual workflows 102, the number of workflows 102, the number of execution schedules 106 may vary. The specifics given and discussed are to help provide explanation and understanding of concepts of the present disclosure and are not meant to be limiting.

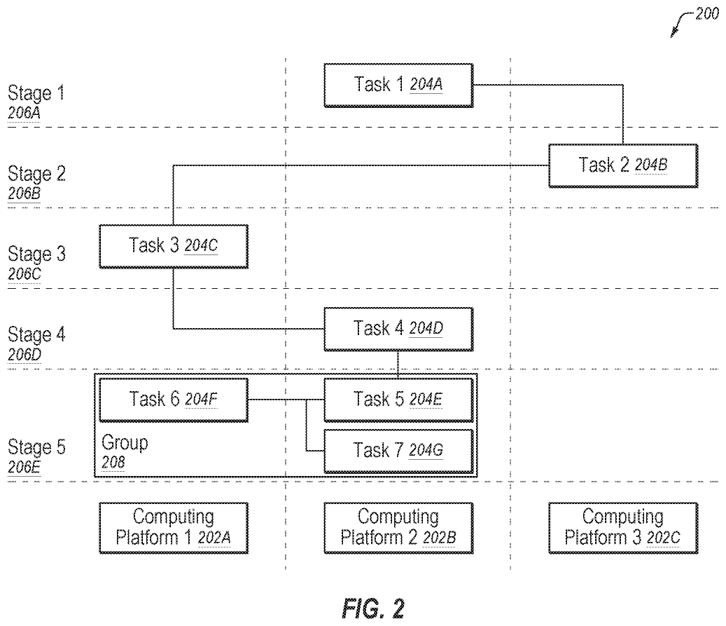

FIG. 2 is an example implementation of an execution schedule 200, in accordance with one or more embodiments of the present disclosure. In these and other embodiments, the execution schedule 200 may be an example of and/or analogous to the execution schedule(s) 106 described and/or illustrated further in the present disclosure, such as, for example, with respect to FIG. 1. In some embodiments, the execution schedule 200 may be an example of scheduling tasks corresponding to a particular workflow 102 that may be described and/or illustrated further in the present disclosure, such as, for example, with respect to FIG. 1. Additionally or alternatively, the execution schedule 200 may be an example of scheduling tasks corresponding to multiple workflows 102 that may be described and/or illustrated further in the present disclosure, such as, for example, with respect to FIG. 1.

In some embodiments, the execution schedule 200 may designate that one or more tasks 204 may be executed. In some embodiments, the execution schedule 200 may designate a first task 204A, a second task 204B, a third task 204C, a fourth task 204D, a fifth task 204E, a sixth task 204F, and a seventh task 204G, collectively referred to as (“tasks 204”) to be executed. In some embodiments, individual respective tasks may include one or more corresponding operations. Further, reference to executing the tasks 204 may include executing one or more operations corresponding to the tasks 204. In some embodiments, the tasks 204 may be the same as and/or analogous to the tasks described as part of the workflow(s) 102 described and/or illustrated further in the present disclosure, such as, for example, with respect to FIG. 1.

In some embodiments, the tasks 204 may be scheduled based on one or more dependencies, current availability of computing resources, time needed to execute the tasks 204, among other considerations described further in the present disclosure, such as, for example, with respect to FIG. 1.

In some embodiments, the tasks 204 may be designated and/or assigned to one or more stages 206, individual stages 206 may represent a period during which one or more tasks 204 may be executed. The execution schedule 200 as illustrated in FIG. 2 may include a first stage 206A, a second stage 206B, a third stage 206C, a fourth stage 206D, and a fifth stage 206E (collectively “stages 206”). In some embodiments, the individual stages 206 may include one or more tasks 204 to be executed. For example, the first stage 206A may include a first task 204A to be executed, the second stage 206B may include a second task 204B to be executed, the third stage 206C may include the third task 204C to be executed, and so on.

In some embodiments, the individual stages 206 may be executed sequentially. For example, the first task 204A corresponding to the first stage 206A may be executed, thereafter the second task 204B corresponding to the second stage 206B may be executed, and so on. In some embodiments, individual stages may be executed separately. In some embodiments, rather than executing tasks 204 corresponding to respective stages 206 immediately one after the other, tasks 204 corresponding to respective stages 206 may be executed at any time after any dependencies have been met. For example, the first task 204A corresponding to the first stage 206A may be executed. Continuing the example, the second task 204B corresponding to the second stage 206B may then be executed at a later time period.

In some embodiments, individual stages 206 may be executed to encourage an efficient use of computing resources. For example, the first task 204A corresponding to the first stage 206A may be executed. Thereafter, another first task corresponding to another first stage associated with another execution schedule may be executed. Continuing the example, upon completion of the execution of the other first task corresponding to the other execution schedule, the second task 204B corresponding to the second stage 206B associated with the execution schedule 200 may then be executed.

In some embodiments, multiple tasks 204 may be designated for execution in a single stage 206. In some embodiments, one or more groups (e.g., group 208) may include two or more tasks 204 that may be interdependent. In some embodiments, two or more interdependent tasks 204 may respectively include operations whose execution may be interdependent. As illustrated in the execution schedule 200, the fifth stage 206E may include a group 208.

In some embodiments, the group 208 may include the fifth task 204E, the sixth task 204F, and the seventh task 204G. In some embodiments, the fifth task 204E, the sixth task 204F, and the seventh task 204G may include operations whose execution may be interdependent. In some embodiments, in response to the tasks 204 included in the group 208 being interdependent, the fifth task 204E, the sixth task 204F, and the seventh task 204G may be designated for execution at the same time or substantially the same time.

In some embodiments, the execution schedule 200 may indicate one or more computing platforms 202 on which one or more tasks 204 corresponding to respective stages 206 may be executed. In some embodiments, the execution schedule 200 may include a first computing platform 202A, a second computing platform 202B, and a third computing platform 202C. In some embodiments, the first computing platform 202A may be different from the second computing platform 202B that may be different from the third computing platform 202C. For example, the first computing platform 202A may include a CPU, the second computing platform 202B may include a GPU, and the third computing platform may include a second type of GPU.

In the execution schedule 200, the columns corresponding to the computing platforms 202 may indicate which tasks 204 may be designated for execution using each computing platform 202. For example, the third task 204C and the sixth task 204F may be designated for execution using the first computing platform 202A. Continuing the example, the first task 204A, the fourth task 204D, the fifth task 204E, and the seventh task 204G may be designated for execution using the second computing platform 202B. Further, the second task 204B may be designated for execution using the third computing platform 202C.

In some embodiments, the computing platforms 202 may execute different tasks 204 at the same time or substantially the same time to satisfy interdependencies between tasks 204 included in one or more groups 208. For example, during the fifth stage 206E, the sixth task 204F may be designated for execution on the first computing platform 202A at the same time or substantially the same time as the fifth task 204E and the seventh task 204G are being executed in the second computing platform 202B.

In these and other embodiments, the computing platforms 202 that may execute one or more tasks 204 may be identified or otherwise determined, for example, using the one or more workflows 102 described further in the present disclosure, such as, for example, with respect to FIG. 1.

FIG. 2 additionally illustrates an example end to end workflow that may include operations corresponding to various tasks 204. In some embodiments, the execution of the various tasks 204 may be scheduled using one or more schedulers, such as, for example, the scheduler 104 described and/or illustrated further in the present disclosure, such as, for example, with respect to FIG. 1. Additionally or alternatively, the execution of the various tasks 204 may be initialized using one or more execution modules that may be described and/or illustrated further in the present disclosure, such as, for example, the execution module 108.

In some embodiments, the workflow 200 may be based on one or more DAGs, specifications, execution instructions, etc. that may indicate one or more tasks 204 that may be executed. In the illustrated example, the workflow 200 may include a first stage 206A a second stage 206B, a third stage 206C, a fourth stage 206D, and a fifth stage 206E where one or more tasks 204 may be scheduled for execution. In some embodiments, the workflow 200 may result in training one or more machine learning models and testing software corresponding to one or more machines based on the one or more trained machine learning models.

In some embodiments, the workflow 200 may include a first computing platform 202A that may include a first type of CPU, a second computing platform 202B that may include multiple CPUs and GPUs that may be configured for rendering, and a third computing platform 202C that may include a number of GPUs that may be designed particularly for machine learning. In some embodiments, each of the first computing platform 202A, the second computing platform 202B, and the third computing platform 202C may be different from each other such that different tasks 204 may be scheduled on either the first computing platform 202A, the second computing platform 202B, or the third computing platform 202C based on execution instructions corresponding to the task 204.

The first task 204A may include data processing, the second task 204B may include training an AI model, the third task 204C may include evaluating the accuracy of the trained AI model from the second task 204B, the fourth task 204D may include generating one or more test scenes corresponding to the AI model and/or hardware corresponding to the AI model, the fifth task 204E may include simulating the test scenes corresponding to the fourth task 204D, the sixth task 204F may include testing the software during the simulation of the fifth task 204E, and the seventh task 204G may include visually debugging the software being tested corresponding to the sixth task 204F. The workflow 200 including the tasks 204 may be described in further detail below.

For example, the first task 204A may include data processing. In some embodiments, data processing may include performing one or more operations on one or more datasets. In some embodiments, data processing may include data collection, data maintenance (e.g., data standardization, removing duplicates, data correction, etc.), data transformation, generating synthetic data, etc. In some embodiments, the data processing corresponding to the first task 204A may be performed in preparation for one or more additional tasks, such as, for example, the second task 204B, the third task 204C, and so on. For example, the data processing corresponding to the first task 204A may include generating synthetic data for use, for example, in the second task 204B which may include training a particular AI model. In some embodiments, the data processing corresponding to the first task 204A may be executed using the second computing platform 202B, the multiple CPUs and GPUs designed and/or configured particularly for rendering.

In some embodiments, the data processing corresponding to the first task 204A may be performed during the first stage 206A. In some embodiments, the first stage 206A may be wholly separate from the second stage 206B. Additionally or alternatively, the second stage 206B may begin executing the second task at some point after the first task 204A may have begun executing. In some embodiments, tasks 204 being executed during the second stage 206B, the third stage 206C, and so on, may be executed concurrently with the first stage 206A and/or a portion of the first stage 206A.

In some embodiments, the second task 204B may include training one or more AI models using, for example, data that may result from the data processing of the first task 204A. In some embodiments, the AI training may be performed using the third computing platform 202C including a number of GPUs designed and configured particularly for machine learning. In some embodiments, training the AI model corresponding to the second task 204B may include training one or more models to perform a specific task. In some instances, the specific task may correspond to one or more of the tasks 204 associated with the workflow 200.

In some embodiments, the second task 204B may be executed during the second stage 206B. The second stage 206B may be executed after the execution of the first task 204A and/or concurrently with the first task 204A. In some embodiments, the second stage 206B may be executed before the third stage 206C and/or concurrently with the tasks corresponding to the third stage 206C, and so on.

The third task 204C may include evaluating one or more aspects of the AI model that may have been trained during execution of the second task. For example, an accuracy corresponding to the AI model may be evaluated based on one or more criteria. For example, in some instances, the accuracy of the AI model may be evaluated based on target hardware that may use the trained AI model. In some embodiments, the third task 204C may be executed on the first computing platform 202A and during the third stage 206C.

In some embodiments, one or more test scenes corresponding to the fourth task 204D may be generated. The test scenes may be generated based on the AI models associated with the second task 204B and/or the third task 204C that may have been trained and/or evaluated. In some embodiments, the one or more test scenes may be generated using the second computing platform 202B. Further, in some embodiments, the one or more generated test scenes may be used to execute one or more additional tasks (e.g., the fifth task 204E, the sixth task 204F, and/or the seventh task 204G).

In some embodiments, the fifth task 204E, the sixth task 204F, and the seventh task 204G may be initialized for execution concurrently as a group, e.g., group 208. In some embodiments, each of the tasks 204 corresponding to the group 208 may be executed at the same time. Additionally or alternatively, the tasks 204 corresponding to the group may include some overlapping execution time. In some embodiments, the fifth task 204E, the sixth task 204F and the seventh task 204G may include one or more operations that may be interdependent such that execution of one of the tasks 204 depends from one of the other tasks 204 corresponding to the group 208.

In the present example, the fifth task 204E may include simulating the one or more trained and/or evaluated AI models using the test scenes that may have been generated corresponding to the fourth task 204D. In some embodiments, the sixth task 204F may include testing the software corresponding to the simulation that may be executed corresponding to the fifth task 204E. In some embodiments, the software may be tested along with the trained AI model using, for example, the one or more test scenes. Further, the seventh task may include visually debugging the software associated with the software under test corresponding to the sixth task 204F. In some embodiments, the simulation corresponding to the fifth task 204E may be executed concurrently with the software testing corresponding to the sixth task 204F and concurrently with the visual debugging of the software under test corresponding to the seventh task 204G.

In some embodiments, the group 208 may be executed at the same time or substantially the same time. Further, in some embodiments, the software under test may be executed using the CPUs corresponding to the first computing platform 202A and the simulation and visual debugging may be executed using the multiple CPUs and GPUs associated with the second computing platform 202B.

In some embodiments, one or more outputs may be generated by executing the tasks 204 corresponding to the group 208. For example, the logs corresponding to testing the software may be generated, the results of the simulation(s) corresponding to the fifth task 204E may be generated, etc. In some embodiments, the one or more outputs may be transmitted or otherwise communicated to one or more systems, entities, machines, etc.

Modifications, additions, or omissions may be made to FIG. 2 without departing from the scope of the present disclosure. For example, the number of tasks 204, the number of stages 206, the number of computing platforms 202 may vary. Additionally or alternatively, the number of execution schedules 200 may vary. In some embodiments, the number of groups 208 corresponding to the execution schedule 200 may vary. The specifics given and discussed are to help provide explanation and understanding of concepts of the present disclosure and are not meant to be limiting.

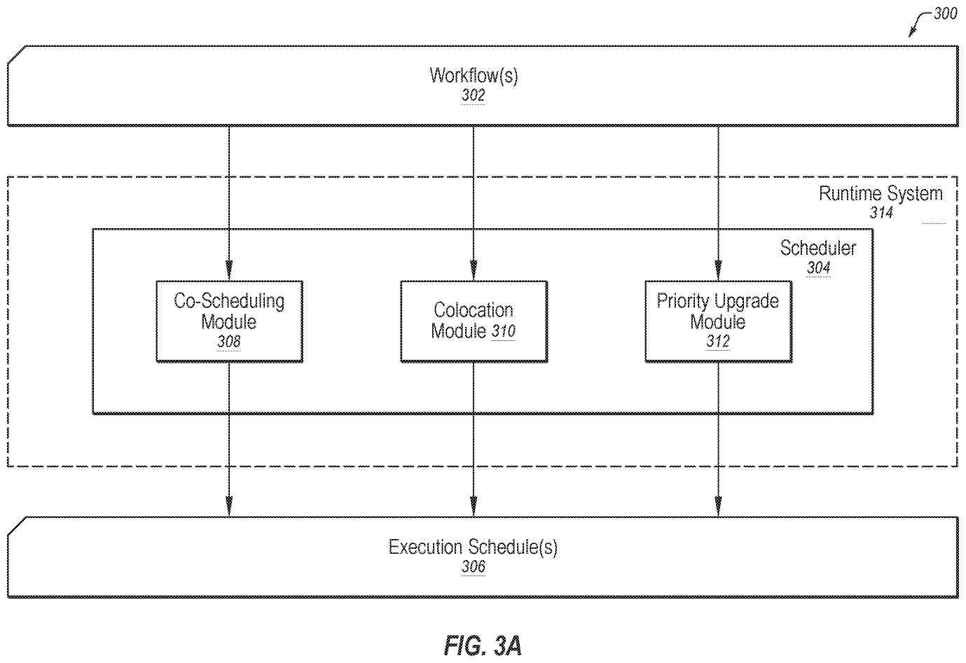

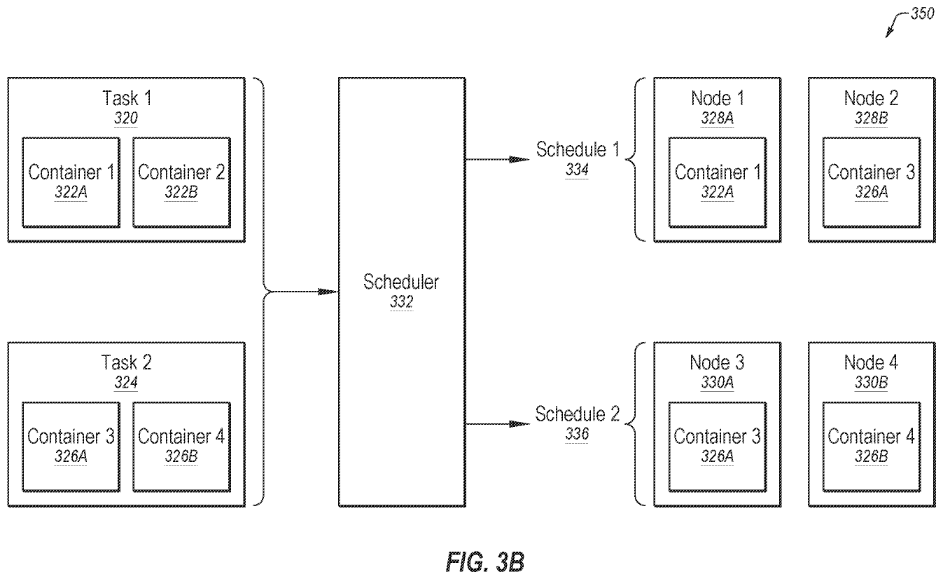

FIG. 3A illustrates an example environment 300 for generating one or more execution schedules 306 using one or more workflows 302, in accordance with one or more embodiments of the present disclosure. In some embodiments, the environment 300 may include a scheduler 304 included in a runtime system 314 that may be configured to perform one or more operations using the information corresponding to the workflow(s) 302 to generate one or more execution schedules 306.

The workflow(s) 302 may include a collection of tasks that may be executed. In some embodiments, the workflow(s) 302 may be the same as and/or analogous to the workflows 102 described and/or illustrated further in the present disclosure, such as, for example, with respect to FIG. 1.

In some embodiments, the information associated with the workflows 302 may include an estimated period of time during which respective tasks may be executed. For example, it may be estimated that a first task may be executed in a certain number of hours—e.g., 6 hours, 12 hours, 24 hours, etc. Furthermore, in some embodiments, the information associated with the workflow(s) 302 may include one or more timeout periods corresponding to respective tasks. The timeout periods may indicate an amount of time to leave a particular task running before cancelling and/or pausing execution of the particular task. In some embodiments, for example, a particular timeout period may be a multiple of the estimated execution time corresponding to an individual task. For example, a particular task may correspond to an estimated execution time. Continuing the example, the particular task may also correspond to a timeout period of 2-times the estimated execution time, 3-times the estimated execution time, and so on.

Additionally or alternatively, the information associated with one or more workflows 302 may include network topology on which tasks, containers, and/or corresponding operations may be executed. Network topology including, for example, network connectivity, layout of nodes, links, devices, etc. corresponding to the computing platforms. For example, one or more tasks, containers, and/or operations may be interdependent and, as a result, the interdependent tasks, containers, and/or operations may be scheduled on computing platforms with the same or similar network topology (e.g., good network connectivity between computing platforms).

Further, the information corresponding to the workflows 302 may include metadata, such as, for example, timestamps indicating when respective workflows 302 may have been generated and/or otherwise created. The metadata may additionally include user and/or system information including information indicating to what systems, subsystems, users, developers, entities, etc. the workflows 302 may correspond.

In some embodiments, the scheduler 304 may be configured to generate one or more execution schedules 306. In these and other embodiments, the scheduler 304 may be the same as and/or analogous to the scheduler 106 that may be described and/or illustrated further in the present disclosure, such as, for example, with respect to FIG. 1. In some embodiments, the scheduler 304 may be included in the runtime system 314 such that the execution schedule(s) 306 may be generated in real-time or substantially real-time much like the execution schedules 106 generated using the scheduler 106 described with respect to FIG. 1.

In some embodiments, the scheduler 304 may correspond to one or more scheduling platforms, such as, for example, one or more containerized scheduling platforms that may be configured to schedule one or more tasks for execution corresponding to a workflow 302. Some example implementations of containerized scheduling and/or orchestration platforms include Kubernetes, Docker Swarm, Amazon Elastic Container Serve (“ECS”), Google Cloud Run, and/or other scheduling platforms that may schedule and/or otherwise designate one or more tasks to be executed corresponding to the workflow(s) 302.

In some embodiments, the scheduler 304 may additionally include one or more modules that may be configured to perform one or more operations using information corresponding to the workflows 302. The one or more modules may provide additional functionality for scheduling tasks corresponding to the workflow(s) 302. In some embodiments, the scheduler 304 may include a co-scheduling module 308, a colocation module 310, and/or a priority upgrade module 312. In some embodiments, the individual modules included in the scheduler 304 may contribute to the generation and/or the creation of the execution schedules 306.

In some embodiments, the co-scheduling module 308, the colocation module 310, and/or the priority upgrade module 312 may include code and routines configured to allow a computing system to perform one or more operations. Additionally or alternatively, the co-scheduling module 308, the colocation module 310, and/or the priority upgrade module 312 may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In these and other embodiments, the co-scheduling module 308, the colocation module 310, and/or the priority upgrade module 312 may be implemented using a combination of hardware and software. In the present disclosure, operations described as being performed by any of the respective modules may include operations that the modules may direct a corresponding computing system to perform. In these or other embodiments, the execution module 108 may be implemented by one or more computing devices, such as that described in further detail with respect to FIGS. 6A-6D, 7, and/or 8.

The co-scheduling module 308 may be configured to receive and/or otherwise obtain the workflows 302 and/or information corresponding to the workflows 302. In some embodiments, the co-scheduling module 308 may be configured to schedule operations corresponding to one or more tasks in one or more execution schedules 306 based on the workflow(s) 302 and/or information corresponding to the workflow(s) 302. In some embodiments, the co-scheduling module 308 may be configured to schedule operations corresponding to a particular task together. In some embodiments, scheduling operations corresponding to the particular task together may help to increase the efficiency and availability of computing resources corresponding to computing platforms that may execute the one or more tasks.

In some embodiments, the co-scheduling module 308 may be configured to dynamically schedule one or more tasks and/or containers corresponding to respective tasks. In some embodiments, the co-scheduling module 308 may be configured to generate a queue that may include the one or more tasks and/or corresponding containers associated with the workflow(s) 302. In some embodiments, the queue of tasks and/or corresponding containers may include multiple queues corresponding to tasks and/or corresponding containers that may be designated for execution using a particular computing platform. For example, a first queue may correspond to a first set of tasks and/or containers designated for execution on a first computing platform. Continuing the example a second queue may correspond to a second set of tasks and/or containers that may be designated for execution on a second computing platform.

In some embodiments, the queue(s) may indicate an order in which respective tasks and/or corresponding containers may be executed. The order may be determined based on the workflow(s) 302 and/or information corresponding to the workflow(s) 302. In some embodiments, the co-scheduling module 308 may be configured to dynamically schedule one or more tasks and/or containers based on the workflow(s), the information corresponding to the workflow(s) 302, and/or the current availability of computing resources corresponding to individual computing platforms.

For example, the co-scheduling module 308 may receive a first workflow 302 and a second workflow 302. The first workflow 302 may include a first task including a first container, a second container, and a third container, where the first container, the second container, and the third container may all be scheduled for execution on a first computing platform. Continuing the example, the second workflow 302 may include a first task that may include a first container, where the first container may be scheduled for execution on the first computing platform. Further continuing the example, the first computing platform may include computing resources to execute two containers at the same time. The co-scheduling module 308 may be configured to schedule the first container and the second container associated with the first task to be executed on the first computing resources. Thereafter, the co-scheduling module 308 may be configured to schedule both the first container corresponding to the first task of the second workflow 302 to be scheduled along with the third container corresponding to the first task of the first workflow 302.

In some embodiments, by scheduling one or more containers corresponding to multiple workflows to be executed based on currently available computing resources, the computing resources may be more efficiently used than if containers corresponding to individual tasks may be scheduled and/or designated for execution individually. In comparison, the co-scheduling module 308 may be configured to schedule and/or designate for execution, only containers corresponding to a particular task. For example, scheduling each of the containers corresponding to a first task, thereafter, scheduling each of the containers corresponding to a second task.

In some embodiments, the co-scheduling module 308 may be configured to schedule groups of containers for execution. In some embodiments, multiple containers may be designated for execution together. In some embodiments, the co-scheduling module 308 may only schedule the groups of containers for execution when the computing resources become available to execute each of the containers included in the group of containers at the same time or substantially the same time. In some embodiments, in instances where the computing resources are not yet available, the co-scheduling module 308 may schedule one or more other containers for execution based on availability of computing resources as well as information corresponding to the workflow(s) 302.

For example, a workflow 302 may include a first task that may include a first set of operations and a second set of operations, where the first set of operations may be organized in a first container and the second set of operations may be organized in a second container. Continuing the example, the workflow 302 may designate a particular computing platform on which the first task may be executed. Further, the workflow 302 may designate that the first set of operations (e.g., the first container) and the second set of operations (e.g., the second container) may be executed at the same time or substantially the same time. The co-scheduling module 308, in this example, may generate an execution schedule 306 that may queue the first set of operations and the second set of operations to be executed together at the same time or substantially the same time.

As a comparative example, a workflow 302 may include a first task that may include a first set of operations and a second set of operations, where the first set of operations may be organized in a first container and the second set of operations may be organized in a second container. Continuing the example, the workflow 302 may designate a particular computing platform on which the first task may be designated for execution. Further, the workflow 302 may not include a designation that the first set of operations (e.g., the first container) and the second set of operations (e.g., the second container) may be executed at the same time or substantially the same time. The co-scheduling module, in this example, may generate an execution schedule 306 that may designate that the first set of operations may be executed at a different time or the same time as the second set of operations.

An example implementation of the co-scheduling module 308 in conjunction with the scheduler 304 may be described and/or illustrated in FIG. 3B, FIG. 3B illustrates an example environment 350 including an implementation of designating one or more containers associated with respective tasks for execution, where the respective tasks may correspond to one or more workflows—e.g., the workflow 102 and/or the workflow 302 described and/or illustrated further in the present disclosure, such as, for example, with respect to FIGS. 1 and 3, respectively.

With respect to FIG. 3B, FIG. 3B is an example implementation 350 of a scheduler 332 designating one or more containers to be executed, in accordance with one or more embodiments of the present disclosure. In some embodiments, the example implementation 350 may include a first task 320 and a second task 324, where the first task 320 and the second task 324 may be designated for execution.

In some embodiments, the first task 320 may include a first container 322A and a second container 322B. In some embodiments, the first container 322A may include a first set of operations and the second container may include a second set of operations 322B. In some embodiments, the first container 322A and the second container 322B may be examples of containers as described and/or illustrated further in the present disclosure, such as, for example, with respect to FIGS. 1, 2, and 3A.

In some embodiments, the first task 320 may correspond to a workflow, such as, for example, the workflow(s) 102 and/or the workflow(s) 302 described further in the present disclosure, such as, for example, with respect to FIGS. 1 and 3A.

In some embodiments, the workflow corresponding to the first task 320 may include information designating one or more computing platforms on which the first container 322A and the second container 322B may be executed. In some embodiments, the workflow may not designate a computing platform on which the first container 322A and/or the second container 322B may be executed. In some embodiments, the workflow and/or information corresponding to the workflow may indicate and/or designate that the first container 322A and the second container 322B may be executed on a same computing platform and at the same time and/or substantially the same time. In some embodiments, the workflow may indicate that the first container 322A and the second container 322B must be executed together (e.g., at the same time or substantially the same time), or else not be executed.

In some embodiments, the second task 324 may include a third container 326A and a fourth container 326B. In some embodiments, the third container 326A may include a third set of operations and the fourth container 326B may include a fourth set of operations. In some embodiments, the third container 326A and/or the fourth container 326B may be examples of containers as described and/or illustrated further in the present disclosure, such as, for example, with respect to FIGS. 1, 2, and 3A.

In some embodiments, the second task 324 may correspond to a workflow, such as, for example, the workflow(s) 102 and/or the workflow(s) 302 described further in the present disclosure, such as, for example, with respect to FIGS. 1 and 3A.

In some embodiments, the workflow corresponding to the second task 324 may include information designating one or more computing platforms on which the third container 326A and the fourth container 326B may be executed. In some embodiments, the workflow may not designate a computing platform on which the third container 326A and/or the fourth container 326B may be executed. In some embodiments, the workflow and/or information corresponding to the workflow may indicate and/or designate that the third container 326A and the fourth container 326B may be executed on a same computing platform and at the same time and/or substantially the same time. In some embodiments, the workflow may indicate that the third container 326A and the fourth container 326B must be executed together (e.g., at the same time or substantially the same time), or else not be executed.

In some embodiments, information corresponding to the first task 320 including the first container 322A and/or the second container 322B and/or the second task 324 including the third container 326A and/or the fourth container 326B may be obtained by the scheduler 332. In some embodiments, the scheduler 332 may be an example of and/or analogous to the scheduler 104 and/or the scheduler 304 described and/or illustrated further in the present disclosure, such as, for example, with respect to FIGS. 1 and 3A.

In some embodiments, the scheduler 332 may obtain and/or receive information corresponding to a first task 320 and/or a second task 324. In some embodiments, the first task 320 and the second task 324 may be included in an individual workflow (e.g., the workflow 302). Additionally or alternatively, the first task 320 may be included in a first workflow and the second task 324 may be included in a second workflow, where the first workflow and the second workflow may be examples of the workflow 102 and/or the workflow 302 described and/or illustrated in the present disclosure, such as, for example, with respect to FIGS. 1 and 3A.

In some embodiments, the scheduler 332 may be configured to schedule one or more tasks (e.g., the first task 320 and/or the second task 324) including one or more corresponding containers (e.g., the first container 322A, the second container 322B, the third container 326A and/or the fourth container 326B) to be executed using one or more computing platforms. In some embodiments, the scheduler 332 may be configured to schedule the tasks and/or containers for execution based on information corresponding to one or more workflows associated, for example, with the first task 320 and/or the second task 324. Additionally or alternatively, the scheduler 328 may designate one or more tasks and/or containers for execution based on a current availability of computing resources.

In some embodiments, the scheduler 332 may be configured to designate one or more nodes on which the tasks and/or corresponding containers may be executed, the nodes corresponding to one or more computing platforms. In some embodiments, the one or more nodes may include respective representations of computing and/or processing resources on which one or more tasks, containers, and/or operations may be executed. For example, a computing platform may include a GPU that may include one or more nodes, each of the one or more nodes may represent resources associated with the GPU that may execute one or more containers. In some embodiments, the scheduler 332 may be configured to designate one or more containers (e.g., the first container 322A, the second container 322B, the third container 326A, and/or the fourth container 326B) to be executed using one or more nodes associated with one or more computing platforms. In some embodiments, the scheduler 332 may be configured to generate one or more schedules, for example, the first schedule 334 and/or the second schedule 336.

In some embodiments, the first schedule 334 may include a first node 328A and/or a second node 328B. In some embodiments, the scheduler 332 may designate the first container 322A to be executed on the first node 328A and the third container 326A to be executed on the second node 328B. In instances where the first container 322A and the second container 322B and/or the third container 326A and the fourth container 326B must be scheduled together, scheduling the first container 322A and the third container 326A may result in neither the first container 322A or the third container 326A being executed.

In comparison, the second schedule 336 may include a third node 330A and a fourth node 330B. In some embodiments, the scheduler 332 may designate the third container 326A to be executed on the third node 330A and the fourth container 326B to be executed on the fourth node 330B. In instances where the third container 326A and the fourth container 326B must be scheduled together, the third container 326A and the fourth container 326B may be executed. In some embodiments, two or more containers that may be scheduled together may be designated in one or more container groups. The container groups indicating that the scheduler 332 may wait for computing resources to become available prior to scheduling the containers corresponding to the container group.

Modifications, additions, or omissions may be made to FIG. 3B without departing from the scope of the present disclosure. For example, the number of tasks, the number of containers corresponding to respective tasks, the number of schedulers, the number of nodes and schedules configured to schedule execution of one or more tasks and/or one or more containers, may vary. The specifics given and discussed are to help provide explanation and understanding of concepts of the present disclosure and are not meant to be limiting.

Returning to FIG. 3A, in some embodiments, the co-scheduling module 308 may be configured to schedule multiple tasks to be executed at the same time or substantially the same time. For example, one or more groups of tasks may be scheduled as described and/or illustrated further in the present disclosure, such as, for example, with respect to FIGS. 1 and 2. For example, a first task and a second task may be designated to be executed at the same time or substantially the same time based on, for example, information corresponding to one or more workflow(s) 302. The first task may be designated to be executed on a first computing platform and the second task may be designated to be executed on a second computing platform. Further continuing the example, the co-scheduling module 308 may schedule the first task on the first computing platform at the same time or substantially the same time as the second task on the second computing platform. Additionally or alternatively, the first task and the second task may be designated for execution on the same computing platform.

In some embodiments, the scheduler 304 may additionally include the colocation module 310. In some embodiments, the colocation module 310 may be configured to obtain the workflow(s) 302 and/or information corresponding to the workflow(s) 302. Additionally or alternatively, the colocation module 310 may be configured to schedule one or more tasks and/or one or more containers corresponding to the one or more tasks to be executed using computing platforms that may conform with network requirements corresponding to the tasks, containers, and/or operations that may be executed.

In some embodiments, the colocation module 310 may be configured to assign to one or more tasks, containers, and/or operations a location key that may indicate one or more network and/or location properties. The network and/or location properties indicating a similar physical location and/or network topology such that the tasks, containers, and/or operations corresponding to the same location key may have a suitable network topology for execution. For example, a first task and a second task corresponding to a particular workflow 302 may be interdependent and, as a result, the first task and the second task may be executed together. In some embodiments, first task and the second task may communicate with each other in order to execute one or more operations. In some embodiments, as a result of this interdependency, the colocation module 310 may be configured to schedule the first task and the second task on one or more computing platforms that may include the same or similar network location, connectivity, etc.

In some embodiments, the scheduler 304 may additionally include the priority upgrade module 312. In some embodiments, the priority upgrade module 312 may indicate one or more levels of priority that may be attached to one or more tasks, containers, and/or operations to be executed. In some embodiments, the levels of priority may indicate which tasks, containers, and/or operations may be executed first. For example, a second workflow 302 may be received after a first workflow 302. Continuing the example, a task corresponding to the second workflow 302 may include a high priority such that the task corresponding to the second workflow 302 may be executed prior to one or more other tasks corresponding to the first workflow 302.

In some embodiments, the priority upgrade module 312 may be configured to upgrade one or more priority levels corresponding to tasks, containers, and/or operations that may be based on an amount of time the task, container, and/or operation may be waiting to be scheduled. For example, one or more tasks, containers, and/or operations corresponding to a first workflow 302 may be included in a queue. In some embodiments, the scheduler 304 may be configured to schedule tasks, containers, and/or operations in the queue based on the information corresponding to the workflow 302 and/or current availability of computing resources. Continuing the example, in instances where a particular task may be in the queue for longer than a predetermined amount of time, the priority upgrade module 312 may upgrade one or more priority levels corresponding to the particular task such that the particular task may be scheduled before one or more other tasks, containers, and/or operations. In some instances, upgrading a particular task in this manner may result in waiting for sufficient computing resources to become available to execute the particular task.

In some embodiments, upgrading one or more tasks, containers, and/or operations may increase efficient use of computing resources and decrease the probability that a particular task, container, operation and/or group of the foregoing may remain in the queue thereby allowing tasks, containers, and/or groups corresponding to the same workflow 302 to be scheduled.

In some embodiments, the scheduler 304, the co-scheduling module 308, the colocation module 310, and/or the priority upgrade module 312 may be included in the runtime system 314. In some embodiments, the determinations made using the scheduler 304, the co-scheduling module 308, the colocation module 310, and/or the priority upgrade module 312 may be made in real-time or substantially real-time based on the information corresponding to the workflows 302 and current availability of computing resources corresponding to the one or more computing platforms.

In some embodiments, the scheduler 304, the co-scheduling module 308, the colocation module 310, and/or the priority upgrade module 312 may contribute to generating one or more execution schedules 306. In these and other embodiments, the execution schedule(s) 306 may be the same as, and/or analogous to the execution schedule(s) 106 and the example execution schedule 200 that may be described and/or illustrated further in the present disclosure, such as, for example, with respect to FIGS. 1 and 2.

Modifications, additions, or omissions may be made to FIG. 3A without departing from the scope of the present disclosure. For example, the number of workflows 302, the number and/or type of system corresponding to the scheduler 304, the number of modules—e.g., the co-scheduling module 308, the number of colocation modules 310, the number of priority upgrade modules 312. Additionally or alternatively, the number of execution schedules 306 may vary. The specifics given and discussed are to help provide explanation and understanding of concepts of the present disclosure and are not meant to be limiting.

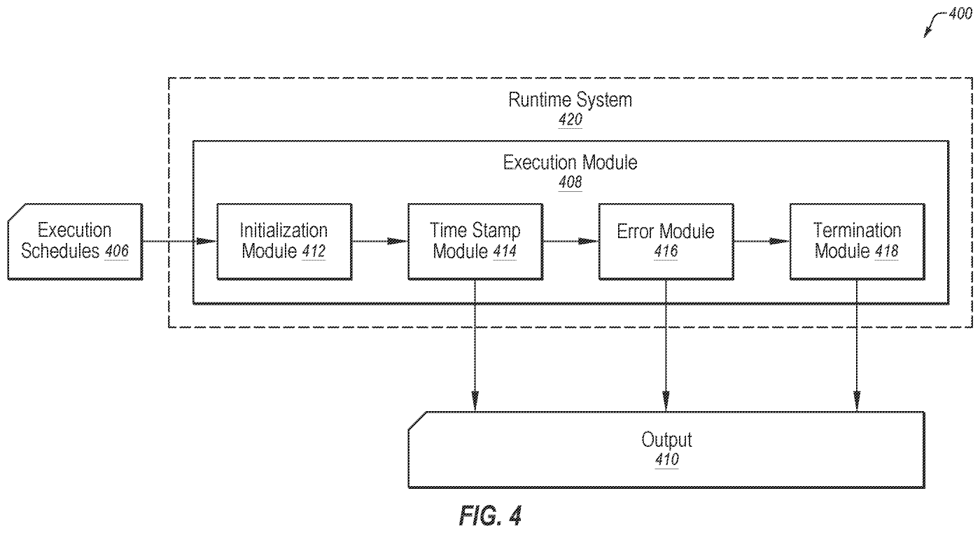

FIG. 4 illustrates an example environment 400 for generating one or more outputs 410 based on executing one or more workflows corresponding to one or more execution schedules 406, in accordance with one or more embodiments of the present disclosure. In these and other embodiments, the execution schedule(s) 406 may be the same as and/or analogous to the execution schedule(s) 106 and/or the execution schedule(s) 306 described and/or illustrated further in the present disclosure, such as, for example, with respect to FIGS. 1 and 3A. In some embodiments, the execution schedule(s) 406 may be generated and/or created in real-time or substantially real-time based on the workflows, the information corresponding to the workflows (e.g., the execution information) and/or the availability of resources associated with one or more computing platforms. In some embodiments, the execution schedule(s) 406 may be sent, transmitted, and/or otherwise communicated to the execution module 408.

In some embodiments, the execution module 408 may be included in a runtime system 420 such that the one or more determinations and/or operations performed using the execution module 408 may be performed in real-time or in substantially real-time. In these and other embodiments, the runtime system 420 corresponding to the environment 400 may be the same as and/or analogous to the runtime system 314 that may be described and/or illustrated further in the present disclosure, such as, for example, with respect to FIG. 3A.

In some embodiments, the execution module 408 may be configured to receive and/or otherwise obtain the execution schedule(s) 406. Additionally or alternatively, the execution module 408 may be configured to generate one or more outputs 410 based on the execution of one or more tasks, containers, and/or operations corresponding to the execution schedule(s) 406. In some embodiments, the execution module 408 may include one or more modules that may be configured to generate the output(s) 410. For example, as shown in FIG. 4, the execution module 408 may include an initializing module 412, a time stamp module 414, an error module 416, and/or a termination module 418.

In some embodiments, the execution module, the initializing module 412, the time stamp module 414, the error module 416, and/or the termination module 418 may include code and routines configured to allow a computing system to perform one or more operations. Additionally or alternatively, the modules may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In these and other embodiments, the respective modules may be implemented using a combination of hardware and software. In the present disclosure, operations described as being performed by any of the respective modules may include operations that the modules may direct a corresponding computing system to perform. In these or other embodiments, the execution module, the initializing module 412, the time stamp module 414, the error module 416, and/or the termination module 418 may be implemented by one or more computing devices, such as those described in further detail with respect to FIGS. 6A-6D, 7, and/or 8.

The initialization module 412 may be configured to initialize execution of one or more tasks, containers, operations, etc. according to the execution schedule(s) 406. In some embodiments, the initialization module 412 may direct one or more computing platforms (e.g., one or more nodes associated with one or more computing platforms) to execute the one or more tasks, containers, and/or operations corresponding to the execution schedule(s) 406.

In some embodiments, in response to the initialization module 412 directing one or more computing platforms to execute one or more tasks, containers, and/or operations, the execution module 408 may be configured to monitor the execution of the tasks, containers, and/or operations using, for example, the time stamp module 414, the error module 416, and/or the termination module 418.

In some embodiments, the time stamp module 414 may be configured to assign a timestamp to the one or more tasks, containers, and/or operations being executed. In some embodiments, by assigning respective timestamps to respective tasks that may be executed, the one or more timeouts corresponding to the workflow(s) may be determined. For example, an individual task may correspond to a particular workflow. Continuing the example, the particular workflow may indicate a time after which the individual task may be terminated. In some embodiments, to determine an amount of time that may have passed after initializing execution, the time stamp module 414 may assign a timestamp to the task at the time execution has been initialized.

In some embodiments, the time stamp module 414 may be configured to generate one or more queries during runtime to determine whether the task, container, operation, etc. may have completed execution. In some embodiments, the time stamp module 414 may generate a query at the designated timeout period corresponding to respective tasks, containers, operations, etc. In some embodiments, the time stamp module 414 may determine that the task, container, operation, etc. may still be running and/or executing, or that the task, container, operation, etc. may have finished executing. In instances where the task, container, operation, etc. is not finished executing after the designated timeout period, the time stamp module 414 may be configured to communicate that information to the error module 416 and/or the termination module 418.

In some embodiments, the error module 416 may be configured to determine whether one or more errors may have occurred during execution. In some embodiments, the error module 416 may receive data and/or information from the time stamp module 414 that may indicate the task, container, operation, etc. may still be running and/or executing after a corresponding timeout period. Additionally or alternatively, the error module 416 may be configured to generate one or more queries that may elicit information associated with execution of one or more tasks from corresponding computing platforms.

In some embodiments, the queries may elicit error information associated with executing one or more tasks, containers, operations, etc. For example, errors may include errors in the code (e.g., syntax errors, logic errors, etc.), network errors, file input/output operation errors, security errors, memory errors, and/or other errors that may be encountered during execution of one or more tasks, containers, and/or operations. Additionally or alternatively, the error module 416 may generate error information as part of the output 410. For example, the error module 416 may generate logs corresponding to tasks, containers, operations, etc., where the logs include information corresponding to the error(s), such as, for example, what the error(s) may have been, potential causes of the error(s), possible ramifications of the error(s) to one or more other systems, subsystems, machines, etc. In some embodiments, the error module 416 may configured to communicate the error information to the termination module 418.

The termination module 418 may be configured to cancel and/or pause execution of the one or more tasks, containers, and/or operations based on error information that may have been detected using, for example, the error module 416. In some embodiments, the termination module 418 may stop and/or pause execution of respective tasks, containers, operations, etc. regardless of error type. Additionally or alternatively, the termination module 418 may stop and/or pause execution of respective tasks, containers, and/or operations based on what error(s) may be detected. For example, tasks executing beyond a designated timeout period may be stopped, while tasks including one or more minor syntax errors may continue to be executed. In some embodiments, the termination module 418 may communicate information associated with stopping and/or pausing execution of one or more tasks, containers, operations, etc. as part of the output 410.

In some embodiments, absent one or more detected errors, the execution module 408, the initialization module 412, the time stamp module 414, the error module 416, and/or the termination module 418 may indicate that the task, container, operation, etc. may have completed executing without error. Further, in some embodiments, results corresponding to tasks, containers, operations, etc. that may have been executed, may be included in the output 410. In these and other embodiments, the output 410 may be the same as and/or analogous to the output 110 that may be described and/or illustrated further in the present disclosure, such as, for example, with respect to FIG. 1.

Modifications, additions, or omissions may be made to FIG. 4 without departing from the scope of the present disclosure. For example, the number of execution schedules 406 may vary. Additionally or alternatively, the workflow execution module 408 may correspond to one or more various types of systems, subsystems, machines, etc. In some embodiments, the functionality described with respect to FIG. 4 and, in particular, the functionality described with respect to the initialization module 412, the time stamp module 414, the error module 416, and/or the termination module 418 may be generated using one or more other modules, systems, subsystems, etc. The specifics given and discussed are to help provide explanation and understanding of concepts of the present disclosure and are not meant to be limiting.

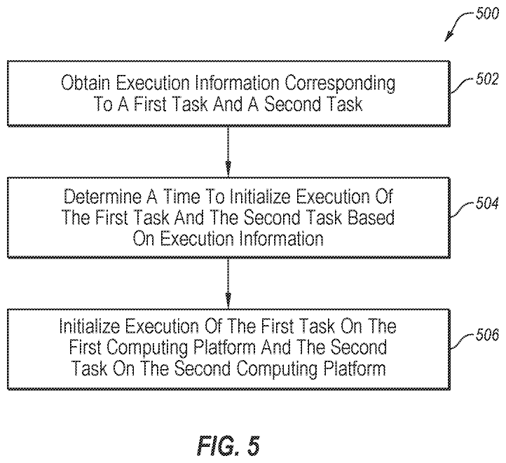

FIG. 5 is a flow diagram showing a method 500 for initializing execution of one or more tasks corresponding to respective workflows, in accordance with one or more embodiments of the present disclosure. The method 500 may include one or more blocks 502, 504, and 506. Although illustrated with discrete blocks, the operations associated with one or more of the blocks of the method 500 may be divided into additional blocks, combined into fewer blocks, or eliminated, depending on the particular implementation.

In some embodiments, the method 500 may include block 502. At block 502, execution information corresponding to a first task and a second task may be obtained. In some embodiments, the first obtained task may include one or more first containers that may include first operations and the second task may include one or more second containers that may include second operations. In some embodiments, the execution information may identify one or more first dependencies that may correspond to the first task. In some embodiments, one or more second dependencies may correspond to the second task. In some embodiments, a first computing platform on which the first task is to be executed may be identified and a second computing platform on which the second task may be executed may additionally be identified using the execution information. In some embodiments, the first computing platform may be different from the second computing platform. In some embodiments, the first computing platform and/or the second computing platform may include one or more of a CPU, a GPU, a TPU, a FPGA, a DPU, a PPU, an ASIC, and/or a DLA.

At block 504, a time to initialize execution of the first task and the second task may be determined in real-time or substantially real-time. In some embodiments, the determination of the time to initialize execution may be determined based on the execution information corresponding to the first task and the second task. In some embodiments, the execution information may identify one or more first dependencies corresponding to the first task and one or more second dependencies corresponding to the second task. In some embodiments, the execution information may additionally include a first computing platform on which the first task is to be executed and a second computing platform on which the second task is to be executed, where the first computing platform may be different from the second computing platform.

In some embodiments, the execution information may additionally include a current availability of computing resources that may correspond to the first computing platform and the second computing platform. In some embodiments, current availability of computing resources may allow for one or more tasks, containers, and/or operations to be scheduled for execution in real-time or substantially real-time.

In some embodiments, the execution information may additionally include a first timeout period that may correspond to the first task and a second timeout period that may correspond to the second task. In some embodiments, the first timeout period and the second timeout period may indicate a time period after which execution of the first operations and the second operations are terminated, respectively. In some embodiments, the first timeout period and the second timeout period may be the same.

At block 506, execution of the first task on the first computing platform and the second task on the second computing platform may be initialized. In some embodiments, the execution of the one or more first containers and the one or more second containers may be interdependent.

Modifications, additions, or omissions may be made to the method 500 and/or one or more operations included in the method 500 without departing from the scope of the present disclosure. For example, the operations corresponding to the method 500 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

### Example Autonomous Vehicle

FIG. 6A is an illustration of an example autonomous vehicle 600, in accordance with some embodiments of the present disclosure. The autonomous vehicle 600 (alternatively referred to herein as the “vehicle 600”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 600 may be capable of functionality in accordance with one or more of Level 3-Level 5 of the autonomous driving levels. The vehicle 600 may be capable of functionality in accordance with one or more of Level 1-Level 5 of the autonomous driving levels. For example, the vehicle 600 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 600 or other machine, such as being fully autonomous, being highly autonomous, being conditionally autonomous, being partially autonomous, providing assistive autonomy, being semi-autonomous, being primarily autonomous, or other designation.

The vehicle 600 may include components such as a chassis, a vehicle body, wheels (e.g., 2, 4, 6, 8, 18, etc.), tires, axles, and other components of a vehicle. The vehicle 600 may include a propulsion system 650, such as an internal combustion engine, hybrid electric power plant, an all-electric engine, and/or another propulsion system type. The propulsion system 650 may be connected to a drive train of the vehicle 600, which may include a transmission, to enable the propulsion of the vehicle 600. The propulsion system 650 may be controlled in response to receiving signals from the throttle/accelerator 652.

A steering system 654, which may include a steering wheel, may be used to steer the vehicle 600 (e.g., along a desired path or route) when the propulsion system 650 is operating (e.g., when the vehicle is in motion). The steering system 654 may receive signals from a steering actuator 656. The steering wheel may be optional for full automation (Level 5) functionality.

The brake sensor system 646 may be used to operate the vehicle brakes in response to receiving signals from the brake actuators 648 and/or brake sensors.

Controller(s) 636, which may include one or more CPU(s), system on chips (SoCs) 604 (FIG. 6C) and/or GPU(s), may provide signals (e.g., representative of commands) to one or more components and/or systems of the vehicle 600. For example, the controller(s) may send signals to operate the vehicle brakes via one or more brake actuators 648, to operate the steering system 654 via one or more steering actuators 656, and/or to operate the propulsion system 650 via one or more throttle/accelerators 652. The controller(s) 636 may include one or more onboard (e.g., integrated) computing devices (e.g., supercomputers) that process sensor signals, and output operation commands (e.g., signals representing commands) to enable autonomous driving and/or to assist a human driver in driving the vehicle 600. The controller(s) 636 may include a first controller 636 for autonomous driving functions, a second controller 636 for functional safety functions, a third controller 636 for artificial intelligence functionality (e.g., computer vision), a fourth controller 636 for infotainment functionality, a fifth controller 636 for redundancy in emergency conditions, and/or other controllers. In some examples, a single controller 636 may handle two or more of the above functionalities, two or more controllers 636 may handle a single functionality, and/or any combination thereof.

The controller(s) 636 may provide the signals for controlling one or more components and/or systems of the vehicle 600 in response to sensor data received from one or more sensors (e.g., sensor inputs). The sensor data may be received from, for example and without limitation, global navigation satellite systems sensor(s) 658 (e.g., Global Positioning System sensor(s)), RADAR sensor(s) 660, ultrasonic sensor(s) 662, LIDAR sensor(s) 664, inertial measurement unit (IMU) sensor(s) 666 (e.g., accelerometer(s), gyroscope(s), magnetic compass(es), magnetometer(s), etc.), microphone(s) 696, stereo camera(s) 668, wide-view camera(s) 670 (e.g., fisheye cameras), infrared camera(s) 672, surround camera(s) 674 (e.g., 360 degree cameras), long-range and/or mid-range camera(s) 698, speed sensor(s) 644 (e.g., for measuring the speed of the vehicle 600), vibration sensor(s) 642, steering sensor(s) 640, brake sensor(s) 646 (e.g., as part of the brake sensor system 646), and/or other sensor types.

One or more of the controller(s) 636 may receive inputs (e.g., represented by input data) from an instrument cluster 632 of the vehicle 600 and provide outputs (e.g., represented by output data, display data, etc.) via a human-machine interface (HMI) display 634, an audible annunciator, a loudspeaker, and/or via other components of the vehicle 600. The outputs may include information such as vehicle velocity, speed, time, map data (e.g., the HD map 622 of FIG. 6C), location data (e.g., the location of the vehicle 600, such as on a map), direction, location of other vehicles (e.g., an occupancy grid), information about objects and status of objects as perceived by the controller(s) 636, etc. For example, the HMI display 634 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 600 further includes a network interface 624, which may use one or more wireless antenna(s) 626 and/or modem(s) to communicate over one or more networks. For example, the network interface 624 may be capable of communication over LTE, WCDMA, UMTS, GSM, CDMA2000, etc. The wireless antenna(s) 626 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 6B is an example of camera locations and fields of view for the example autonomous vehicle 600 of FIG. 6A, in accordance with some embodiments of the present disclosure. The cameras and respective fields of view are one example embodiment and are not intended to be limiting. For example, additional and/or alternative cameras may be included and/or the cameras may be located at different locations on the vehicle 600.

The camera types for the cameras may include, but are not limited to, digital cameras that may be adapted for use with the components and/or systems of the vehicle 600. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom-designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 600 (e.g., front-facing cameras) may be used for surround view, to help identify forward-facing paths and obstacles, as well aid in, with the help of one or more controllers 636 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 670 that may be used to perceive objects coming into view from the periphery (e.g., pedestrians, crossing traffic or bicycles). Although only one wide-view camera is illustrated in FIG. 6B, there may any number of wide-view cameras 670 on the vehicle 600. In addition, long-range camera(s) 698 (e.g., a long-view stereo camera pair) may be used for depth-based object detection, especially for objects for which a neural network has not yet been trained. The long-range camera(s) 698 may also be used for object detection and classification, as well as basic object tracking.

One or more stereo cameras 668 may also be included in a front-facing configuration. The stereo camera(s) 668 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 668 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 668 may be used in addition to, or alternatively from, those described herein.

Cameras with a field of view that include portions of the environment to the side of the vehicle 600 (e.g., side-view cameras) may be used for surround view, providing information used to create and update the occupancy grid, as well as to generate side impact collision warnings. For example, surround camera(s) 674 (e.g., four surround cameras 674 as illustrated in FIG. 6B) may be positioned to on the vehicle 600. The surround camera(s) 674 may include wide-view camera(s) 670, fisheye camera(s), 360-degree camera(s), and/or the like. For example, four fisheye cameras may be positioned on the vehicle's front, rear, and sides. In an alternative arrangement, the vehicle may use three surround camera(s) 674 (e.g., left, right, and rear), and may leverage one or more other camera(s) (e.g., a forward-facing camera) as a fourth surround-view camera.

Cameras with a field of view that include portions of the environment to the rear of the vehicle 600 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 698, stereo camera(s) 668), infrared camera(s) 672, etc.), as described herein.

FIG. 6C is a block diagram of an example system architecture for the example autonomous vehicle 600 of FIG. 6A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 600 in FIG. 6C is illustrated as being connected via bus 602. The bus 602 may include a Controller Area Network (CAN) data interface (alternatively referred to herein as a “CAN bus”). A CAN may be a network inside the vehicle 600 used to aid in control of various features and functionality of the vehicle 600, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 602 is described herein as being a CAN bus, this is not intended to be limiting. For example, in addition to, or alternatively from, the CAN bus, FlexRay and/or Ethernet may be used. Additionally, although a single line is used to represent the bus 602, this is not intended to be limiting. For example, there may be any number of busses 602, which may include one or more CAN busses, one or more FlexRay busses, one or more Ethernet busses, and/or one or more other types of busses using a different protocol. In some examples, two or more busses 602 may be used to perform different functions, and/or may be used for redundancy. For example, a first bus 602 may be used for collision avoidance functionality and a second bus 602 may be used for actuation control. In any example, each bus 602 may communicate with any of the components of the vehicle 600, and two or more busses 602 may communicate with the same components. In some examples, each SoC 604, each controller 636, and/or each computer within the vehicle may have access to the same input data (e.g., inputs from sensors of the vehicle 600), and may be connected to a common bus, such the CAN bus.

The vehicle 600 may include one or more controller(s) 636, such as those described herein with respect to FIG. 6A. The controller(s) 636 may be used for a variety of functions. The controller(s) 636 may be coupled to any of the various other components and systems of the vehicle 600 and may be used for control of the vehicle 600, artificial intelligence of the vehicle 600, infotainment for the vehicle 600, and/or the like.

The vehicle 600 may include a system(s) on a chip (SoC) 604. The SoC 604 may include CPU(s) 606, GPU(s) 608, processor(s) 610, cache(s) 612, accelerator(s) 614, data store(s) 616, and/or other components and features not illustrated. The SoC(s) 604 may be used to control the vehicle 600 in a variety of platforms and systems. For example, the SoC(s) 604 may be combined in a system (e.g., the system of the vehicle 600) with an HD map 622 which may obtain map refreshes and/or updates via a network interface 624 from one or more servers (e.g., server(s) 678 of FIG. 6D).

The CPU(s) 606 may include a CPU cluster or CPU complex (alternatively referred to herein as a “CCPLEX”). The CPU(s) 606 may include multiple cores and/or L2 caches. For example, in some embodiments, the CPU(s) 606 may include eight cores in a coherent multi-processor configuration. In some embodiments, the CPU(s) 606 may include four dual-core clusters where each cluster has a dedicated L2 cache (e.g., a 2 MB L2 cache). The CPU(s) 606 (e.g., the CCPLEX) may be configured to support simultaneous cluster operation enabling any combination of the clusters of the CPU(s) 606 to be active at any given time.

The CPU(s) 606 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 606 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 608 may include an integrated GPU (alternatively referred to herein as an “iGPU”). The GPU(s) 608 may be programmable and may be efficient for parallel workloads. The GPU(s) 608, in some examples, may use an enhanced tensor instruction set. The GPU(s) 608 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 608 may include at least eight streaming microprocessors. The GPU(s) 608 may use compute application programming interface(s) (API(s)). In addition, the GPU(s) 608 may use one or more parallel computing platforms and/or programming models (e.g., NVIDIA's CUDA).

The GPU(s) 608 may be power-optimized for best performance in automotive and embedded use cases. For example, the GPU(s) 608 may be fabricated on a Fin field-effect transistor (FinFET). However, this is not intended to be limiting, and the GPU(s) 608 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread-scheduling capability to enable finer-grain synchronization and cooperation between parallel threads. The streaming microprocessors may include a combined L1 data cache and shared memory unit in order to improve performance while simplifying programming.

The GPU(s) 608 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 608 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 608 to access the CPU(s) 606 page tables directly. In such examples, when the GPU(s) 608 memory management unit (MMU) experiences a miss, an address translation request may be transmitted to the CPU(s) 606. In response, the CPU(s) 606 may look in its page tables for the virtual-to-physical mapping for the address and transmits the translation back to the GPU(s) 608. As such, unified memory technology may allow a single unified virtual address space for memory of both the CPU(s) 606 and the GPU(s) 608, thereby simplifying the GPU(s) 608 programming and porting of applications to the GPU(s) 608.

In addition, the GPU(s) 608 may include an access counter that may keep track of the frequency of access of the GPU(s) 608 to memory of other processors. The access counter may help ensure that memory pages are moved to the physical memory of the processor that is accessing the pages most frequently.

The SoC(s) 604 may include any number of cache(s) 612, including those described herein. For example, the cache(s) 612 may include an L3 cache that is available to both the CPU(s) 606 and the GPU(s) 608 (e.g., that is connected to both the CPU(s) 606 and the GPU(s) 608). The cache(s) 612 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 604 may include an arithmetic logic unit(s) (ALU(s)) which may be leveraged in performing processing with respect to any of the variety of tasks or operations of the vehicle 600—such as processing DNNs. In addition, the SoC(s) 604 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 606 and/or GPU(s) 608.

The SoC(s) 604 may include one or more accelerators 614 (e.g., hardware accelerators, software accelerators, or a combination thereof). For example, the SoC(s) 604 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 608 and to off-load some of the tasks of the GPU(s) 608 (e.g., to free up more cycles of the GPU(s) 608 for performing other tasks). As an example, the accelerator(s) 614 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 614 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 608, and by using an inference accelerator, for example, a designer may target either the DLA(s) or the GPU(s) 608 for any function. For example, the designer may focus processing of CNNs and floating point operations on the DLA(s) and leave other functions to the GPU(s) 608 and/or other accelerator(s) 614.

The accelerator(s) 614 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 606. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 614 (e.g., the hardware acceleration cluster) may include a computer vision network on-chip and SRAM, for providing a high-bandwidth, low latency SRAM for the accelerator(s) 614. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 604 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 614 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to processed RADAR. In other examples, the PVA is used for time of flight depth processing, by processing raw time of flight data to provide processed time of flight data, for example.

The DLA may be used to run any type of network to enhance control and driving safety, including, for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 666 output that correlates with the vehicle 600 orientation, distance, 3D location estimates of the object obtained from the neural network and/or other sensors (e.g., LIDAR sensor(s) 664 or RADAR sensor(s) 660), among others.

The SoC(s) 604 may include data store(s) 616 (e.g., memory). The data store(s) 616 may be on-chip memory of the SoC(s) 604, which may store neural networks to be executed on the GPU and/or the DLA. In some examples, the data store(s) 616 may be large enough in capacity to store multiple instances of neural networks for redundancy and safety. The data store(s) 616 may comprise L2 or L3 cache(s) 612. Reference to the data store(s) 616 may include reference to the memory associated with the PVA, DLA, and/or other accelerator(s) 614, as described herein.

The SoC(s) 604 may include one or more processor(s) 610 (e.g., embedded processors). The processor(s) 610 may include a boot and power management processor that may be a dedicated processor and subsystem to handle boot power and management functions and related security enforcement. The boot and power management processor may be a part of the SoC(s) 604 boot sequence and may provide runtime power management services. The boot power and management processor may provide clock and voltage programming, assistance in system low power state transitions, management of SoC(s) 604 thermals and temperature sensors, and/or management of the SoC(s) 604 power states. Each temperature sensor may be implemented as a ring-oscillator whose output frequency is proportional to temperature, and the SoC(s) 604 may use the ring-oscillators to detect temperatures of the CPU(s) 606, GPU(s) 608, and/or accelerator(s) 614. If temperatures are determined to exceed a threshold, the boot and power management processor may enter a temperature fault routine and put the SoC(s) 604 into a lower power state and/or put the vehicle 600 into a chauffeur to safe-stop mode (e.g., bring the vehicle 600 to a safe stop).

The processor(s) 610 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 610 may further include an always-on processor engine that may provide necessary hardware features to support low power sensor management and wake use cases. The always-on processor engine may include a processor core, a tightly coupled RAM, supporting peripherals (e.g., timers and interrupt controllers), various I/O controller peripherals, and routing logic.

The processor(s) 610 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 610 may further include a real-time camera engine that may include a dedicated processor subsystem for handling real-time camera management.

The processor(s) 610 may further include a high dynamic range signal processor that may include an image signal processor that is a hardware engine that is part of the camera processing pipeline.

The processor(s) 610 may include a video image compositor that may be a processing block (e.g., implemented on a microprocessor) that implements video post-processing functions needed by a video playback application to produce the final image for the player window. The video image compositor may perform lens distortion correction on wide-view camera(s) 670, surround camera(s) 674, and/or on in-cabin monitoring camera sensors. An in-cabin monitoring camera sensor is preferably monitored by a neural network running on another instance of the Advanced SoC, configured to identify in-cabin events and respond accordingly. In-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 608 is not required to continuously render new surfaces. Even when the GPU(s) 608 is powered on and active doing 3D rendering, the video image compositor may be used to offload the GPU(s) 608 to improve performance and responsiveness.

The SoC(s) 604 may further include a mobile industry processor interface (MIPI) camera serial interface for receiving video and input from cameras, a high-speed interface, and/or a video input block that may be used for camera and related pixel input functions. The SoC(s) 604 may further include an input/output controller(s) that may be controlled by software and may be used for receiving I/O signals that are uncommitted to a specific role.

The SoC(s) 604 may further include a broad range of peripheral interfaces to enable communication with peripherals, audio codecs, power management, and/or other devices. The SoC(s) 604 may be used to process data from cameras (e.g., connected over Gigabit Multimedia Serial Link and Ethernet), sensors (e.g., LIDAR sensor(s) 664, RADAR sensor(s) 660, etc. that may be connected over Ethernet), data from bus 602 (e.g., speed of vehicle 600, steering wheel position, etc.), data from GNSS sensor(s) 658 (e.g., connected over Ethernet or CAN bus). The SoC(s) 604 may further include dedicated high-performance mass storage controllers that may include their own DMA engines, and that may be used to free the CPU(s) 606 from routine data management tasks.

The SoC(s) 604 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 604 may be faster, more reliable, and even more energy-efficient and space-efficient than conventional systems. For example, the accelerator(s) 614, when combined with the CPU(s) 606, the GPU(s) 608, and the data store(s) 616, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 620) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path-planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path-planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 608.

In some examples, a CNN for facial recognition and vehicle owner identification may use data from camera sensors to identify the presence of an authorized driver and/or owner of the vehicle 600. The always-on sensor processing engine may be used to unlock the vehicle when the owner approaches the driver door and turn on the lights, and, in security mode, to disable the vehicle when the owner leaves the vehicle. In this way, the SoC(s) 604 provide for security against theft and/or carjacking.

In another example, a CNN for emergency vehicle detection and identification may use data from microphones 696 to detect and identify emergency vehicle sirens. In contrast to conventional systems, that use general classifiers to detect sirens and manually extract features, the SoC(s) 604 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 658. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 662, until the emergency vehicle(s) passes.

The vehicle may include a CPU(s) 618 (e.g., discrete CPU(s), or dCPU(s)), that may be coupled to the SoC(s) 604 via a high-speed interconnect (e.g., PCIe). The CPU(s) 618 may include an X86 processor, for example. The CPU(s) 618 may be used to perform any of a variety of functions, including arbitrating potentially inconsistent results between ADAS sensors and the SoC(s) 604, and/or monitoring the status and health of the controller(s) 636 and/or infotainment SoC 630, for example.

The vehicle 600 may include a GPU(s) 620 (e.g., discrete GPU(s), or dGPU(s)), that may be coupled to the SoC(s) 604 via a high-speed interconnect (e.g., NVIDIA's NVLINK). The GPU(s) 620 may provide additional artificial intelligence functionality, such as by executing redundant and/or different neural networks, and may be used to train and/or update neural networks based on input (e.g., sensor data) from sensors of the vehicle 600.

The vehicle 600 may further include the network interface 624 which may include one or more wireless antennas 626 (e.g., one or more wireless antennas for different communication protocols, such as a cellular antenna, a Bluetooth antenna, etc.). The network interface 624 may be used to enable wireless connectivity over the Internet with the cloud (e.g., with the server(s) 678 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 600 information about vehicles in proximity to the vehicle 600 (e.g., vehicles in front of, on the side of, and/or behind the vehicle 600). This functionality may be part of a cooperative adaptive cruise control functionality of the vehicle 600.

The network interface 624 may include a SoC that provides modulation and demodulation functionality and enables the controller(s) 636 to communicate over wireless networks. The network interface 624 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 600 may further include data store(s) 628, which may include off-chip (e.g., off the SoC(s) 604) storage. The data store(s) 628 may include one or more storage elements including RAM, SRAM, DRAM, VRAM, Flash, hard disks, and/or other components and/or devices that may store at least one bit of data.

The vehicle 600 may further include GNSS sensor(s) 658. The GNSS sensor(s) 658 (e.g., GPS, assisted GPS sensors, differential GPD (DGPS) sensors, etc.), to assist in mapping, perception, occupancy grid generation, and/or path planning functions. Any number of GNSS sensor(s) 658 may be used, including, for example and without limitation, a GPS using a USB connector with an Ethernet to Serial (RS-232) bridge.

The vehicle 600 may further include RADAR sensor(s) 660. The RADAR sensor(s) 660 may be used by the vehicle 600 for long-range vehicle detection, even in darkness and/or severe weather conditions. RADAR functional safety levels may be ASIL B. The RADAR sensor(s) 660 may use the CAN and/or the bus 602 (e.g., to transmit data generated by the RADAR sensor(s) 660) for control and to access object tracking data, with access to Ethernet to access raw data, in some examples. A wide variety of RADAR sensor types may be used. For example, and without limitation, the RADAR sensor(s) 660 may be suitable for front, rear, and side RADAR use. In some example, Pulse Doppler RADAR sensor(s) are used.

The RADAR sensor(s) 660 may include different configurations, such as long-range with narrow field of view, short-range with wide field of view, short-range side coverage, etc. In some examples, long-range RADAR may be used for adaptive cruise control functionality. The long-range RADAR systems may provide a broad field of view realized by two or more independent scans, such as within a 250 m range. The RADAR sensor(s) 660 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 600 surrounding at higher speeds with minimal interference from traffic in adjacent lanes. The other two antennae may expand the field of view, making it possible to quickly detect vehicles entering or leaving the vehicle's 600 lane.

Mid-range RADAR systems may include, as an example, a range of up to 160 m (front) or 80 m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 600 may further include ultrasonic sensor(s) 662. The ultrasonic sensor(s) 662, which may be positioned at the front, back, and/or the sides of the vehicle 600, may be used for park assist and/or to create and update an occupancy grid. A wide variety of ultrasonic sensor(s) 662 may be used, and different ultrasonic sensor(s) 662 may be used for different ranges of detection (e.g., 2.5 m, 4 m). The ultrasonic sensor(s) 662 may operate at functional safety levels of ASIL B.

The vehicle 600 may include LIDAR sensor(s) 664. The LIDAR sensor(s) 664 may be used for object and pedestrian detection, emergency braking, collision avoidance, and/or other functions. The LIDAR sensor(s) 664 may be functional safety level ASIL B. In some examples, the vehicle 600 may include multiple LIDAR sensors 664 (e.g., two, four, six, etc.) that may use Ethernet (e.g., to provide data to a Gigabit Ethernet switch).

In some examples, the LIDAR sensor(s) 664 may be capable of providing a list of objects and their distances for a 360-degree field of view. Commercially available LIDAR sensor(s) 664 may have an advertised range of approximately 100 m, with an accuracy of 2 cm-3 cm, and with support for a 100 Mbps Ethernet connection, for example. In some examples, one or more non-protruding LIDAR sensors 664 may be used. In such examples, the LIDAR sensor(s) 664 may be implemented as a small device that may be embedded into the front, rear, sides, and/or corners of the vehicle 600. The LIDAR sensor(s) 664, in such examples, may provide up to a 120-degree horizontal and 35-degree vertical field-of-view, with a 200 m range even for low-reflectivity objects. Front-mounted LIDAR sensor(s) 664 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 600. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 664 may be less susceptible to motion blur, vibration, and/or shock.

The vehicle may further include IMU sensor(s) 666. The IMU sensor(s) 666 may be located at a center of the rear axle of the vehicle 600, in some examples. The IMU sensor(s) 666 may include, for example and without limitation, an accelerometer(s), a magnetometer(s), a gyroscope(s), a magnetic compass(es), and/or other sensor types. In some examples, such as in six-axis applications, the IMU sensor(s) 666 may include accelerometers and gyroscopes, while in nine-axis applications, the IMU sensor(s) 666 may include accelerometers, gyroscopes, and magnetometers.

In some embodiments, the IMU sensor(s) 666 may be implemented as a miniature, high-performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 666 may enable the vehicle 600 to estimate heading without requiring input from a magnetic sensor by directly observing and correlating the changes in velocity from GPS to the IMU sensor(s) 666. In some examples, the IMU sensor(s) 666 and the GNSS sensor(s) 658 may be combined in a single integrated unit.

The vehicle may include microphone(s) 696 placed in and/or around the vehicle 600. The microphone(s) 696 may be used for emergency vehicle detection and identification, among other things.

The vehicle may further include any number of camera types, including stereo camera(s) 668, wide-view camera(s) 670, infrared camera(s) 672, surround camera(s) 674, long-range and/or mid-range camera(s) 698, and/or other camera types. The cameras may be used to capture image data around an entire periphery of the vehicle 600. The types of cameras used depends on the embodiments and requirements for the vehicle 600, and any combination of camera types may be used to provide the necessary coverage around the vehicle 600. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 6A and FIG. 6B.

The vehicle 600 may further include vibration sensor(s) 642. The vibration sensor(s) 642 may measure vibrations of components of the vehicle, such as the axle(s). For example, changes in vibrations may indicate a change in road surfaces. In another example, when two or more vibration sensors 642 are used, the differences between the vibrations may be used to determine friction or slippage of the road surface (e.g., when the difference in vibration is between a power-driven axle and a freely rotating axle).

The vehicle 600 may include an ADAS system 638. The ADAS system 638 may include a SoC, in some examples. The ADAS system 638 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 660, LIDAR sensor(s) 664, and/or a camera(s). The ACC systems may include longitudinal ACC and/or lateral ACC. Longitudinal ACC monitors and controls the distance to the vehicle immediately ahead of the vehicle 600 and automatically adjust the vehicle speed to maintain a safe distance from vehicles ahead. Lateral ACC performs distance keeping, and advises the vehicle 600 to change lanes when necessary. Lateral ACC is related to other ADAS applications such as LCA and CWS.

CACC uses information from other vehicles that may be received via the network interface 624 and/or the wireless antenna(s) 626 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 600), while the 12V communication concept provides information about traffic further ahead. CACC systems may include either or both I2V and V2V information sources. Given the information of the vehicles ahead of the vehicle 600, CACC may be more reliable, and it has potential to improve traffic flow smoothness and reduce congestion on the road.

FCW systems are designed to alert the driver to a hazard, so that the driver may take corrective action. FCW systems use a front-facing camera and/or RADAR sensor(s) 660, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 660, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 600 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 600 if the vehicle 600 starts to exit the lane. BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s).

RCTW systems may provide visual, audible, and/or tactile notification when an object is detected outside the rear-camera range when the vehicle 600 is backing up. Some RCTW systems include AEB to ensure that the vehicle brakes are applied to avoid a crash. RCTW systems may use one or more rear-facing RADAR sensor(s) 660, coupled to a dedicated processor, DSP, FPGA, and/or ASIC, that is electrically coupled to driver feedback, such as a display, speaker, and/or vibrating component.

Conventional ADAS systems may be prone to false positive results, which may be annoying and distracting to a driver, but typically are not catastrophic, because the ADAS systems alert the driver and allow the driver to decide whether a safety condition truly exists and act accordingly. However, in an autonomous vehicle 600, the vehicle 600 itself must, in the case of conflicting results, decide whether to heed the result from a primary computer or a secondary computer (e.g., a first controller 636 or a second controller 636). For example, in some embodiments, the ADAS system 638 may be a backup and/or secondary computer for providing perception information to a backup computer rationality module. The backup computer rationality monitor may run a redundant diverse software on hardware components to detect faults in perception and dynamic driving tasks. Outputs from the ADAS system 638 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 604.

In other examples, ADAS system 638 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 638 may be fed into the primary computer's perception block and/or the primary computer's dynamic driving task block. For example, if the ADAS system 638 indicates a forward crash warning due to an object immediately ahead, the perception block may use this information when identifying objects. In other examples, the secondary computer may have its own neural network that is trained and thus reduces the risk of false positives, as described herein.

The vehicle 600 may further include the infotainment SoC 630 (e.g., an in-vehicle infotainment system (IVI)). Although illustrated and described as an SoC, the infotainment system may not be a SoC, and may include two or more discrete components. The infotainment SoC 630 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle-related information such as fuel level, total distance covered, brake fuel level, oil level, door open/close, air filter information, etc.) to the vehicle 600. For example, the infotainment SoC 630 may include radios, disk players, navigation systems, video players, USB and Bluetooth connectivity, carputers, in-car entertainment, Wi-Fi, steering wheel audio controls, hands-free voice control, a heads-up display (HUD), an HMI display 634, a telematics device, a control panel (e.g., for controlling and/or interacting with various components, features, and/or systems), and/or other components. The infotainment SoC 630 may further be used to provide information (e.g., visual and/or audible) to a user(s) of the vehicle, such as information from the ADAS system 638, autonomous driving information such as planned vehicle maneuvers, trajectories, surrounding environment information (e.g., intersection information, vehicle information, road information, etc.), and/or other information.

The infotainment SoC 630 may include GPU functionality. The infotainment SoC 630 may communicate over the bus 602 (e.g., CAN bus, Ethernet, etc.) with other devices, systems, and/or components of the vehicle 600. In some examples, the infotainment SoC 630 may be coupled to a supervisory MCU such that the GPU of the infotainment system may perform some self-driving functions in the event that the primary controller(s) 636 (e.g., the primary and/or backup computers of the vehicle 600) fail. In such an example, the infotainment SoC 630 may put the vehicle 600 into a chauffeur to safe-stop mode, as described herein.

The vehicle 600 may further include an instrument cluster 632 (e.g., a digital dash, an electronic instrument cluster, a digital instrument panel, etc.). The instrument cluster 632 may include a controller and/or supercomputer (e.g., a discrete controller or supercomputer). The instrument cluster 632 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 630 and the instrument cluster 632. In other words, the instrument cluster 632 may be included as part of the infotainment SoC 630, or vice versa.

FIG. 6D is a system diagram for communication between cloud-based server(s) and the example autonomous vehicle 600 of FIG. 6A, in accordance with some embodiments of the present disclosure. The system 676 may include server(s) 678, network(s) 690, and vehicles, including the vehicle 600. The server(s) 678 may include a plurality of GPUs 684(A)-684(H) (collectively referred to herein as GPUs 684), PCIe switches 682(A)-682(H) (collectively referred to herein as PCIe switches 682), and/or CPUs 680(A)-680(B) (collectively referred to herein as CPUs 680). The GPUs 684, the CPUs 680, and the PCIe switches may be interconnected with high-speed interconnects such as, for example and without limitation, NVLink interfaces 688 developed by NVIDIA and/or PCIe connections 686. In some examples, the GPUs 684 are connected via NVLink and/or NVSwitch SoC and the GPUs 684 and the PCIe switches 682 are connected via PCIe interconnects. Although eight GPUs 684, two CPUs 680, and two PCIe switches are illustrated, this is not intended to be limiting. Depending on the embodiment, each of the server(s) 678 may include any number of GPUs 684, CPUs 680, and/or PCIe switches. For example, the server(s) 678 may each include eight, sixteen, thirty-two, and/or more GPUs 684.

The server(s) 678 may receive, over the network(s) 690 and from the vehicles, image data representative of images showing unexpected or changed road conditions, such as recently commenced road work. The server(s) 678 may transmit, over the network(s) 690 and to the vehicles, neural networks 692, updated neural networks 692, and/or map information 694, including information regarding traffic and road conditions. The updates to the map information 694 may include updates for the HD map 622, such as information regarding construction sites, potholes, detours, flooding, and/or other obstructions. In some examples, the neural networks 692, the updated neural networks 692, and/or the map information 694 may have resulted from new training and/or experiences represented in data received from any number of vehicles in the environment, and/or based on training performed at a datacenter (e.g., using the server(s) 678 and/or other servers).

The server(s) 678 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 690, and/or the machine learning models may be used by the server(s) 678 to remotely monitor the vehicles.

In some examples, the server(s) 678 may receive data from the vehicles and apply the data to up-to-date real-time neural networks for real-time intelligent inferencing. The server(s) 678 may include deep-learning supercomputers and/or dedicated AI computers powered by GPU(s) 684, such as a DGX and DGX Station machines developed by NVIDIA. However, in some examples, the server(s) 678 may include deep learning infrastructure that use only CPU-powered datacenters.

The deep-learning infrastructure of the server(s) 678 may be capable of fast, real-time inferencing, and may use that capability to evaluate and verify the health of the processors, software, and/or associated hardware in the vehicle 600. For example, the deep-learning infrastructure may receive periodic updates from the vehicle 600, such as a sequence of images and/or objects that the vehicle 600 has located in that sequence of images (e.g., via computer vision and/or other machine learning object classification techniques). The deep-learning infrastructure may run its own neural network to identify the objects and compare them with the objects identified by the vehicle 600 and, if the results do not match and the infrastructure concludes that the AI in the vehicle 600 is malfunctioning, the server(s) 678 may transmit a signal to the vehicle 600 instructing a fail-safe computer of the vehicle 600 to assume control, notify the passengers, and complete a safe parking maneuver.

For inferencing, the server(s) 678 may include the GPU(s) 684 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). In other words, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point, connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that enable the computing device 700 to communicate with other computing devices via an electronic communication network, include wired and/or wireless communications. The communication interface 710 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may enable the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail in the present disclosure) associated with a display of the computing device 700. The computing device 700 may include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that enable detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to enable the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, etc.), and output the data (e.g., as an image, video, sound, etc.).

### Example Data Center

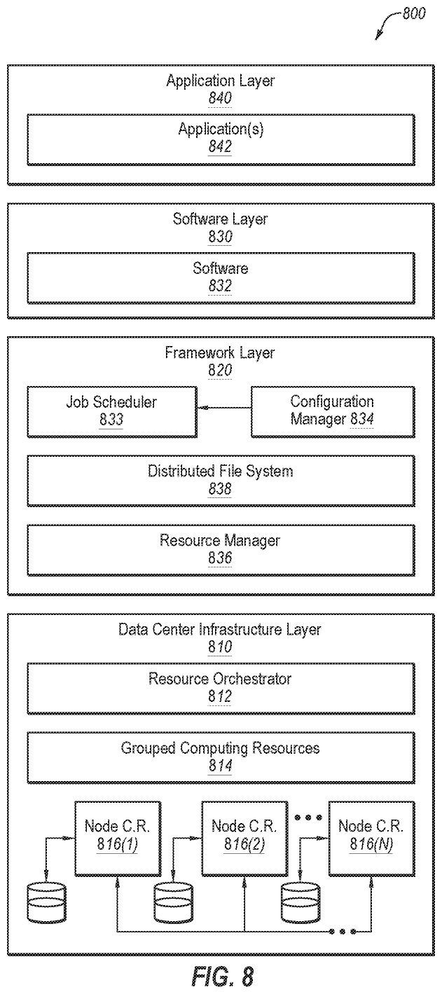

FIG. 8 illustrates an example data center 800 that may be used in at least one embodiments of the present disclosure. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-816(N) may include one or more virtual components, such as vGPUs, vCPUs, and/or the like, and/or one or more of the node C.R.s 816(1)-816(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 832, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 832 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 832. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described in the present disclosure with respect to the data center 800. In at least one embodiment, trained or deployed machine learning models corresponding to one or more neural networks may be used to infer or predict information using resources described in the present disclosure with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described in the present disclosure may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B. Additionally, use of the term “based on” should not be interpreted as “only based on” or “based only on.” Rather, a first element being “based on” a second element includes instances in which the first element is based on the second element but may also be based on one or more additional elements.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A system comprising:
one or more processing units to perform operations comprising:
obtaining execution information corresponding to a first task and a second task, the first task includes one or more first operations and the second task includes one or more second operations, the execution information indicating:
first dependencies corresponding to the first task;
second dependencies corresponding to the second task;
a first computing platform on which the first task is to be executed;
a second computing platform, different from the first computing platform, on which the second task is to be executed; and
a current availability of computing resources corresponding to the first computing platform and the second computing platform;
determining a time to initialize execution of the first task and the second task based at least on the execution information; and
initializing, at the time, execution of the first task on the first computing platform and the second task on the second computing platform, at least one first operation of the one or more first operations being interdependent with at least one second operation of the one or more second operations.

2. The system of claim 1, wherein the execution information further indicates:
a first timeout period corresponding to the first task indicating a time period after which execution of the one or more first operations is terminated; and
a second timeout period corresponding to the second task indicating a time period after which execution of the one or more second operations is terminated.

3. The system of claim 2, wherein the first timeout period and the second timeout period are the same.

4. The system of claim 2, the operations further comprising:
cancelling the execution of the first task on the first computing platform and the second task on the second computing platform based at least on the first timeout period and the second timeout period being reached.

5. The system of claim 1, the operations further comprising:
detecting one or more errors during the execution of the first task or the execution of the second task; and
terminating the execution of the first task or the execution of the second task based at least on the one or more detected errors.

6. The system of claim 1, wherein the first computing platform and the second computing platform includes one or more of a CPU, a GPU, a TPU, a FPGA, a DPU, a PPU, an ASIC, or a DLA.

7. The system of claim 1, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system implementing one or more large language models (LLMs);
a system for generating synthetic data;
a system incorporating one or more virtual machines (VMs);
a system for performing one or more generative AI operations;
a system implemented at least partially in a data center; or
a system implemented at least partially using cloud computing resources.

8. A system comprising:
one or more processing units to perform operations comprising:
obtaining execution information corresponding to a plurality of tasks, the plurality of tasks respectively including one or more containers individually including one or more organized operations, the execution information indicating dependencies respectively corresponding to individual tasks of the plurality of tasks, computing resources on which respective operations corresponding to respective tasks of the plurality of tasks are executed, and the current availability of the computing resources;
determining a plurality of stages to initialize execution of the operations corresponding to the plurality of tasks, the stages ordered sequentially based at least on the execution information, and
initializing execution of the plurality of tasks, wherein:
a first task of the plurality of tasks is executed using a first type of computing platform and a second task of the plurality of tasks is executed using a second type of computing platform;
execution of one or more first containers corresponding to the first task is interdependent on execution of one or more second containers corresponding to the second task; and
the first task and the second task are executed at a same stage of the plurality of stages.

9. The system of claim 8, wherein the execution information further indicates:
a first timeout period corresponding to the first task indicating a time period after which execution of the one or more first containers is terminated; and
a second timeout period corresponding to the second task indicating a time period after which execution of the one or more second containers is terminated.

10. The system of claim 9, wherein the first timeout period and the second timeout period are the same.

11. The system of claim 9, the operations further comprising:
cancelling the execution of the first task on the first type of computing platform and the second task on the second type of computing platform based at least on the first timeout period and the second timeout period being reached.

12. The system of claim 8, the operations further comprising:
detecting one or more errors during the execution of the first task or the execution of the second task; and
terminating the execution of the first task or the execution of the second task based at least on the one or more detected errors.

13. The system of claim 8, wherein the execution information additionally includes one or more priority levels assigned to one or more of the plurality of tasks, a higher priority level assigned to a particular task indicating that the particular task be executed prior to one or more other tasks assigned a lower priority level.

14. The system of claim 7, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

15. A method comprising:
obtaining execution information corresponding to a first task and a second task, the first task including one or more first containers including one or more first operations and the second task including one or more second containers including one or more second operations, the execution information indicating first dependencies corresponding to the first task, second dependencies corresponding to the second task, a first computing platform on which the first task is to be executed, a second computing platform, different from the first computing platform, on which the second task is to be executed, and a current availability of computing resources corresponding to the first computing platform and the second computing platform; and
initializing execution of the first task on the first computing platform and the second task on the second computing platform such that, based at least on the execution information, the one or more first containers and the one or more second containers are interdependent.

16. The method of claim 15, wherein the execution information further includes:
a first timeout period corresponding to the first task indicating a time period after which execution of the one or more first containers is terminated; and
a second timeout period corresponding to the second task indicating a time period after which execution of the one or more second containers is terminated.

17. The method of claim 16, wherein the first timeout period and the second timeout period are the same.

18. The method of claim 16, further comprising:
cancelling the execution of the first task on the first computing platform and the second task on the second computing platform based at least on the first timeout period and the second timeout period being reached.

19. The method of claim 15, further comprising:
detecting one or more errors during the execution of the first task or the execution of the second task; and
terminating the execution of the first task or the execution of the second task based on the one or more detected errors.

20. The method of claim 15, wherein the first computing platform and the second computing platform includes one or more of a CPU, a GPU, a TPU, a FPGA, a DPU, a PPU, an ASIC, or a DLA.
